(19) United States
(12) Patent Application Publication
(10) Pub. No.: US 2015/0030477 A1
(43) Pub. Date: Jan. 29, 2015

(54) SYNTHETIC JET EJECTORS WITH IMPROVED MANUFACTURABILITY

(71) Applicant: NUVENTIX, INC., Austin, TX (US)

(72) Inventors: Daniel N. Grimm, Round Rock, TX (US); Andrew Poynot, Austin, TX (US); Randall P. Williams, Austin, TX (US); Stephen P. Darbin, Austin, TX (US); Lee M. Jones, Austin, TX (US); Raghavendran Mahalingam, Austin, TX (US)

(73) Assignee: NUVENTIX, INC., Austin, TX (US)

(21) Appl. No.: 14/490,804

(22) Filed: Sep. 19, 2014

Related U.S. Application Data
(63) Continuation of application No. PCT/US2013/033770, filed on Mar. 25, 2013.
(60) Provisional application No. 61/614,512, filed on Mar. 23, 2012.

(51) Int. Cl. F04B 43/04; B05B 12/06; F04B 17/04

(52) U.S. Cl. CPC F04B 43/04; F04B 17/042; B05B 12/06
USPC 417/413.1; 165/104.34; 239/102.1; 29/888.02

(57) ABSTRACT

A synthetic jet ejector (201) is provided which includes a chassis (203); first (205) and second (207) opposing synthetic jet actuators mounted in the chassis; and a controller (209) which controls the first and second synthetic jet actuators and which is in electrical contact with the first and second synthetic jet actuators by way of flexible circuitry (211, 213).

### CROSS-REFERENCE TO RELATED APPLICATION

This application claims the benefit of priority from U.S. Provisional Application No. 61/614,512, filed Mar. 23, 2012, having the same title, and having the same inventors, and which is incorporated herein by reference in its entirety.

FIELD OF THE DISCLOSURE

The present disclosure relates generally to synthetic jet ejectors, and more particularly to synthetic jet ejectors having improved manufacturability.

BACKGROUND OF THE DISCLOSURE

A variety of thermal management devices are known to the art, including conventional fan based systems, piezoelectric systems, and synthetic jet ejectors. The latter type of system has emerged as a highly efficient and versatile thermal management solution, especially in applications where thermal management is required at the local level.

Various examples of synthetic jet ejectors are known to the art. Earlier examples are described in U.S. Pat. No. 5,758,823 (Glezer et al.), entitled “Synthetic Jet Actuator and Applications Thereof”; U.S. Pat. No. 5,894,990 (Glezer et al.), entitled “Synthetic Jet Actuator and Applications Thereof”; U.S. Pat. No. 5,988,522 (Glezer et al.), entitled Synthetic Jet Actuators for Modifying the Direction of Fluid Flows”; U.S. Pat. No. 6,056,204 (Glezer et al.), entitled “Synthetic Jet Actuators for Mixing Applications”; U.S. Pat. No. 6,123,145 (Glezer et al.), entitled Synthetic Jet Actuators for Cooling Heated Bodies and Environments”; and U.S. Pat. No. 6,588,497 (Glezer et al.), entitled “System and Method for Thermal Management by Synthetic Jet Ejector Channel Cooling Techniques”.

Further advances have been made in the art of synthetic jet ejectors, both with respect to synthetic jet ejector technology in general and with respect to the applications of this technology. Some examples of these advances are described in U.S. 20100226838 (Mahalingam et al.), entitled “Synthetic Jet Ejector for Augmentation of Pumped Liquid Loop Cooling and Enhancement of Pool and Flow Boiling”; U.S. 20100039012 (Grimm), entitled “Advanced Synjet Cooler Design For LED Light Modules”; U.S. 20100033071 (Heffington et al.), entitled “Thermal management of LED Illumination Devices”; U.S. 20090141065 (Darbin et al.), entitled “Method and Apparatus for Controlling Diaphragm Displacement in Synthetic Jet Actuators”; U.S. 20090109625 (Booth et al.), entitled Light Fixture with Multiple LEDs and Synthetic Jet Thermal Management System”; U.S. 20090084866 (Grimm et al.), entitled Vibration Balanced Synthetic Jet Ejector”; U.S. 20080295997 (Heffington et al.), entitled Synthetic Jet Ejector with Viewing Window and Temporal Aliasing”; U.S. 20080219007 (Heffington et al.), entitled “Thermal Management System for LED Array”; U.S. 20080151541 (Heffington et al.), entitled “Thermal Management System for LED Array”; U.S. 20080043061 (Glezer et al.), entitled “Methods for Reducing the Non-Linear Behavior of Actuators Used for Synthetic Jets”; U.S. 20080009187 (Grimm et al.), entitled “Moldable Housing design for Synthetic Jet Ejector”; U.S. 20080006393 (Grimm), entitled Vibration Isolation System for Synthetic Jet Devices”; U.S. 20070272393 (Reichenbach), entitled “Electronics Package for Synthetic Jet Ejectors”; U.S. 20070141453 (Mahalingam et al.), entitled “Thermal Management of Batteries using Synthetic Jets”; U.S. 20070096118 (Mahalingam et al.), entitled “Synthetic Jet Cooling System for LED Module”; U.S. 20070081027 (Beltran et al.), entitled “Acoustic Resonator for Synthetic Jet Generation for Thermal Management”; U.S. 20070023169 (Mahalingam et al.), entitled “Synthetic Jet Ejector for Augmentation of Pumped Liquid Loop Cooling and Enhancement of Pool and Flow Boiling”; U.S. 20070119573 (Mahalingam et al.), entitled “Synthetic Jet Ejector for the Thermal Management of PCI Cards”; U.S. 20070119575 (Glezer et al.), entitled “Synthetic Jet Heat Pipe Thermal Management System”; U.S. 20070127210 (Mahalingam et al.), entitled “Thermal Management System for Distributed Heat Sources”; U.S. 20070141453 (Mahalingam et al.), entitled “Thermal Management of Batteries using Synthetic Jets”; U.S. Pat. No. 7,252,140 (Glezer et al.), entitled “Apparatus and Method for Enhanced Heat Transfer”; U.S. Pat. No. 7,606,029 (Mahalingam et al.), entitled “Thermal Management System for Distributed Heat Sources”; U.S. Pat. No. 7,607,470 (Glezer et al.), entitled “Synthetic Jet Heat Pipe Thermal Management System”; U.S. Pat. No. 7,760,499 (Darbin et al.), entitled “Thermal Management System for Card Cages”; U.S. Pat. No. 7,768,779 (Heffington et al.), entitled “Synthetic Jet Ejector with Viewing Window and Temporal Aliasing”; U.S. Pat. No. 7,784,972 (Heffington et al.), entitled “Thermal Management System for LED Array”; and U.S. Pat. No. 7,819,556 (Heffington et al.), entitled “Thermal Management System for LED Array”.

### BRIEF DESCRIPTION OF THE DRAWINGS

FIGS. 1A-1C are illustrations depicting the manner in which a synthetic jet actuator operates.

FIG. 2 is an illustration of an embodiment of a synthetic jet ejector engine in accordance with the teachings herein.

FIG. 3 is an illustration of a synthetic jet ejector engine from U.S. 2011/0198056 (Grimm et al.).

FIG. 4 is an illustration of an insert-molded back iron and magnet combination from the embodiment of FIG. 2.

FIG. 5 is an illustration of an insert-molded back iron from U.S. 2011/0198056 (Grimm et al.).

FIG. 6 is an illustration of a top plate/magnet combination from the embodiment of FIG. 2.

FIG. 7 is an illustration of a top plate/magnet combination from U.S. 2011/0198056 (Grimm et al.).

FIG. 8 is an illustration of a diaphragm/bobbin assembly from the embodiment of FIG. 2.

FIG. 9 is an illustration of a diaphragm/bobbin assembly from U.S. 2011/0198056 (Grimm et al.).

FIG. 10 is an illustration of a bobbin from the embodiment of FIG. 2.

FIG. 11 is an illustration of a bobbin from U.S. 2011/0198056 (Grimm et al.).

FIG. 12 is an illustration of a bobbin/flex connector from the embodiment of FIG. 2.

FIG. 13 is an illustration of a bobbin/flex connector from U.S. 2011/0198056 (Grimm et al.).

FIG. 14 is an illustration of a flex connector from the embodiment of FIG. 2.

FIG. 15 is an illustration of a flex connector from U.S. 2011/0198056 (Grimm et al.).

FIGS. 16-18 are illustrations of a first embodiment of a configuration for a flex connector in an engine for a synthetic jet ejector in accordance with the teachings herein.

FIG. 19 is an illustration of a second embodiment of a configuration for a flex connector in an engine for a synthetic jet ejector in accordance with the teachings herein.

FIG. 20 is an illustration of a second embodiment of a configuration for a flex connector in an engine for a synthetic jet ejector in accordance with the teachings herein.

FIGS. 21-22 are illustrations of an embodiment of a bobbin in accordance with the teachings herein which is equipped with bottom terminations.

FIG. 23 is an illustration of an embodiment of a bobbin in accordance with the teachings herein which is equipped with top terminations.

FIGS. 24-25 are illustrations of an embodiment of a bobbin in accordance with the teachings herein which is equipped with side terminations.

FIGS. 26-27 are illustrations of an embodiment of a means for connecting a flex connector to a bobbin in accordance with the teachings herein.

FIGS. 28-29 are illustrations of part of an embodiment of a bobbin in accordance with the teachings herein which is equipped with dual, mirror-image coil formers.

FIG. 30 is an illustration of the interface between the chassis and the back iron in an embodiment of a synthetic jet ejector engine in accordance with the teachings herein.

FIG. 31 is a cross-section taken along LINE 31-31 of FIG. 30.

FIG. 32 is an illustration of a synthetic jet ejector in accordance with the teachings herein.

FIG. 33 is an exploded view of the synthetic jet ejector of FIG. 32.

FIG. 34 is an illustration of the synthetic jet ejector of FIG. 32 with the chassis, the first and second diaphragm and the housing interface removed.

FIG. 35 is an illustration of the synthetic jet ejector of FIG. 32 with the chassis, the first and second diaphragm, the housing interface and the back iron removed.

FIG. 36 is an illustration of a housing interface in accordance with the teachings herein.

FIGS. 37-38 are illustrations of an embodiment of a diaphragm in accordance with the teachings herein.

FIGS. 39-42 are perspective views of an embodiment of a chassis in accordance with the teachings herein.

FIGS. 43-45 are perspective views of an embodiment of a bobbin in accordance with the teachings herein.

### SUMMARY OF THE DISCLOSURE

In one aspect, a synthetic jet ejector is provided which comprises (a) a chassis; (b) first and second opposing synthetic jet actuators mounted in said chassis; and (c) a controller which controls said first and second synthetic jet actuators and which is in electrical contact with said first and second synthetic jet actuators by way of flexible circuitry.

In another aspect, a synthetic jet ejector is provided which comprises (a) a chassis; (b) first and second synthetic jet actuators mounted on opposing ends of said chassis; (c) a PCB mounted on an exterior surface of said chassis; and (d) first and second distinct flexible circuits, wherein each of said flexible circuits has a first end which is in electrical contact with said PCB, and a second end which is in electrical contact with one of said first and second synthetic jet ejectors.

In a further aspect, a synthetic jet ejector is provided which comprises (a) a chassis; (b) at least one synthetic jet actuator supported on said chassis; and (c) a back iron having an essentially annular wall with a plurality of holes therein; wherein said chassis extends through said plurality of holes.

In still another aspect, a synthetic jet ejector is provided which comprises (a) a bobbin; and (b) a diaphragm; wherein said bobbin has a circumferential groove on one end thereof, and wherein said diaphragm has a complimentary-shaped circumferential protrusion which releasably engages said circumferential groove.

In another aspect, a synthetic jet ejector is provided which comprises (a) a back iron; (b) a chassis having a first chassis component disposed outside of the wall of said back iron, and a second chassis component disposed inside the wall of said back iron; and (c) a magnet supported on said second chassis component; wherein said magnet is cylindrical in shape, and wherein said second chassis component contains an annular indentation which is complimentary in shape to a portion of the exterior shape of said magnet.

In yet another aspect, a method for making a synthetic jet ejector is provided which comprises (a) arranging a back iron and magnet within a mold, wherein said back iron has an annular wall with a plurality of apertures therein, and wherein said magnet is disposed within said annular wall; and (b) molding a chassis around said back iron and magnet such that the chassis supports the back iron and the magnet and such that the molding material extends through the apertures in the annular wall.

In another aspect, a method for making a synthetic jet ejector is provided which comprises (a) providing a bobbin having an annular lip with a circumferential groove defined therein; (b) providing an elastomeric diaphragm having a central opening therein, wherein said central opening is equipped with an annular ridge and has a diameter that is essentially the same as the diameter of the annular lip; and (c) positioning the diaphragm with respect to the bobbin such that the annular ridge engages the annular groove.

In a further aspect, a method for making a synthetic jet ejector is provided which comprises (a) providing a bobbin having first and second terminals and having a coil of wire disposed thereon which has first and second ends which are attached to said first and second terminals, respectively; (b) attaching an annular lip with a circumferential groove defined therein; (c) providing an elastomeric diaphragm having a central opening therein, wherein said central opening is equipped with an annular ridge and has a diameter that is essentially the same as the diameter of the annular lip; and (d) positioning the diaphragm with respect to the bobbin such that the annular ridge engages the annular groove.

### DETAILED DESCRIPTION

The systems, devices and methodologies disclosed herein utilize synthetic jet actuators or synthetic jet ejectors. Prior to describing these systems, devices and methodologies, a brief explanation of a typical synthetic jet ejector, and the manner in which it operates to create a synthetic jet, may be useful.

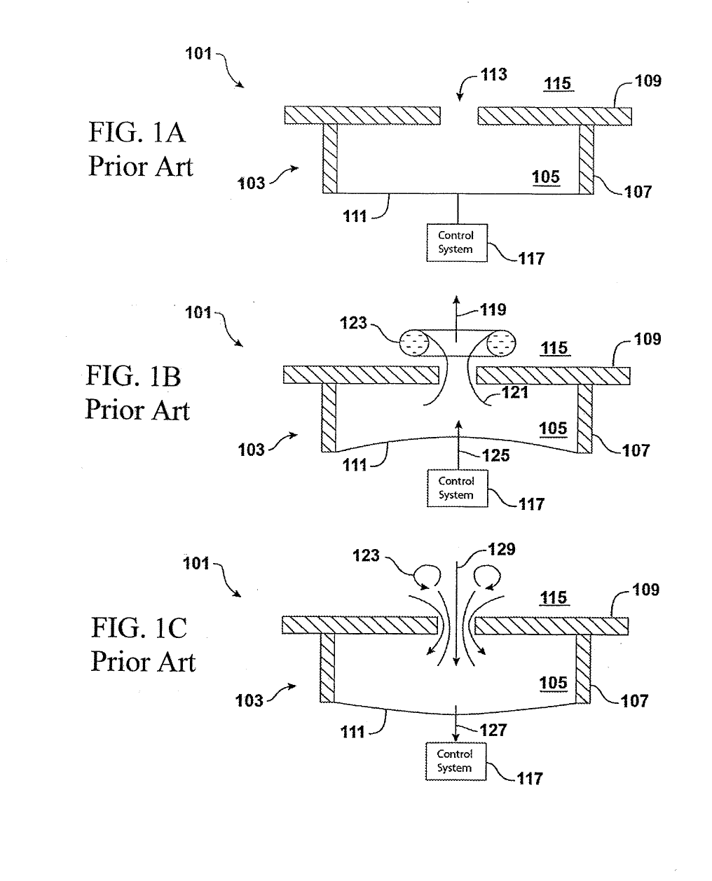

FIG. 1 illustrates the operation of a typical synthetic jet ejector in forming a synthetic jet. As seen therein, the synthetic jet ejector 101 comprises a housing 103 which defines and encloses an internal chamber 105. The housing 103 and chamber 105 may take virtually any geometric configuration, but for purposes of discussion and understanding, the housing 103 is shown in cross-section in FIG. 1 to have a rigid side wall 107, a rigid front wall 109, and a rear diaphragm 111 that is flexible to an extent to permit movement of the diaphragm 111 inwardly and outwardly relative to the chamber 105. The front wall 109 has an orifice 113 therein which may be of various geometric shapes. The orifice 113 diametrically opposes the rear diaphragm 111 and fluidically connects the internal chamber 105 to an external environment having ambient fluid 115.

The movement of the flexible diaphragm 111 may be achieved with a voice coil or other suitable actuator, and may be controlled by a suitable control system 117. The diaphragm 111 may also be equipped with a metal layer, and a metal electrode may be disposed adjacent to, but spaced apart from, the metal layer so that the diaphragm 111 can be moved via an electrical bias imposed between the electrode and the metal layer. Moreover, the generation of the electrical bias can be controlled by any suitable device including, but not limited to, a computer, logic processor, or signal generator. The control system 117 can cause the diaphragm 111 to move periodically or to modulate in time-harmonic motion, thus forcing fluid in and out of the orifice 113.

Alternatively, a piezoelectric actuator could be attached to the diaphragm 111. The control system would, in that case, cause the piezoelectric actuator to vibrate and thereby move the diaphragm 111 in time-harmonic motion. The method of causing the diaphragm 111 to modulate is not particularly limited to any particular means or structure.

The operation of the synthetic jet ejector 101 will now be described with reference to FIGS. 1b-1c. FIG. 1b depicts the synthetic jet ejector 101 as the diaphragm 111 is controlled to move inward into the chamber 105, as depicted by arrow 125. The inward motion of the diaphragm 111 reduces the volume of the chamber 105, thus causing fluid to be ejected through the orifice 113. As the fluid exits the chamber 105 through the orifice 113, the flow separates at the (preferably sharp) edges of the orifice 113 and creates vortex sheets 121. These vortex sheets 121 roll into vortices 123 and begin to move away from the edges of the orifice 109 in the direction indicated by arrow 119.

FIG. 1c depicts the synthetic jet ejector 101 as the diaphragm 111 is controlled to move outward with respect to the chamber 105, as depicted by arrow 127. The outward motion of the diaphragm 111 causes the volume of chamber 105 to increase, thus drawing ambient fluid 115 into the chamber 105 as depicted by the set of arrows 129. The diaphragm 111 is controlled by the control system 117 so that, when the diaphragm 111 moves away from the chamber 105, the vortices 123 are already removed from the edges of the orifice 113 and thus are not affected by the ambient fluid 115 being drawn into the chamber 105. Meanwhile, a jet of ambient fluid 115 is synthesized by the vortices 123, thus creating strong entrainment of ambient fluid drawn from large distances away from the orifice 109.

Many improvements have been made to the design of synthetic jet ejectors since their initial introduction. For example, U.S. Ser. No. 13/026,220, entitled “SYNTHETIC JET EJECTOR AND DESIGN THEREOF TO FACILITATE MASS PRODUCTION”, which was filed on Feb. 12, 2011, which has been published as U.S. 2011/0198056 (Grimm et al.), and which is incorporated herein by reference in its entirety, describes designs for a new class of synthetic jet ejectors which significantly improves the manufacturability of these devices. However, while the designs disclosed in this application represent notable improvements in the art, the need exists for even further improvements in the design of these devices that will even further improve their manufacturability and utility.

It has now been found that the foregoing needs may be addressed with the devices and methodologies disclosed herein. These devices and methodologies may improve and simplify the manufacturing process for synthetic jet ejectors, and may thus reduce the cost of these devices.

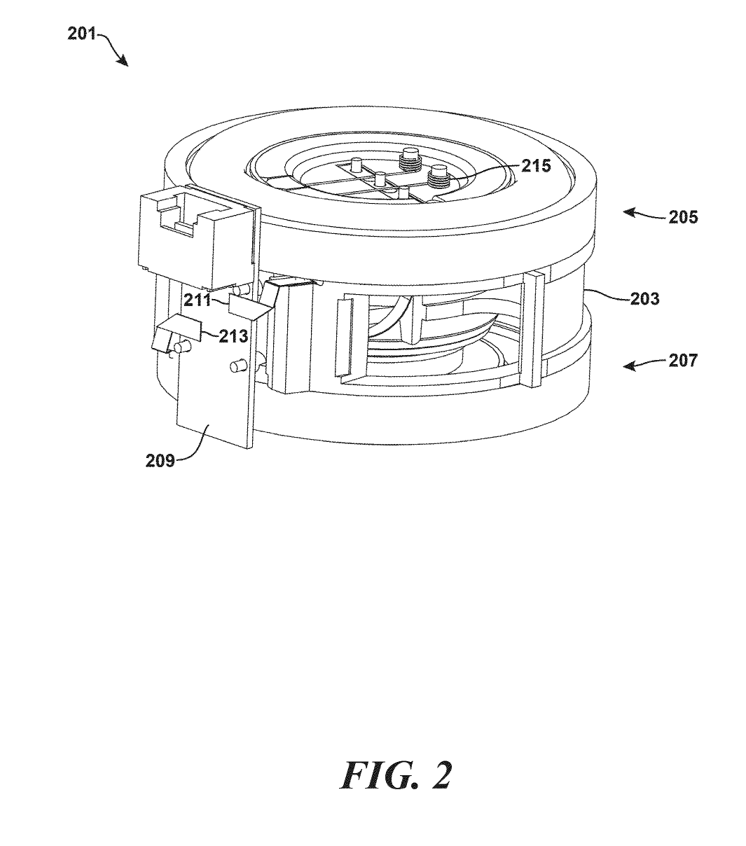

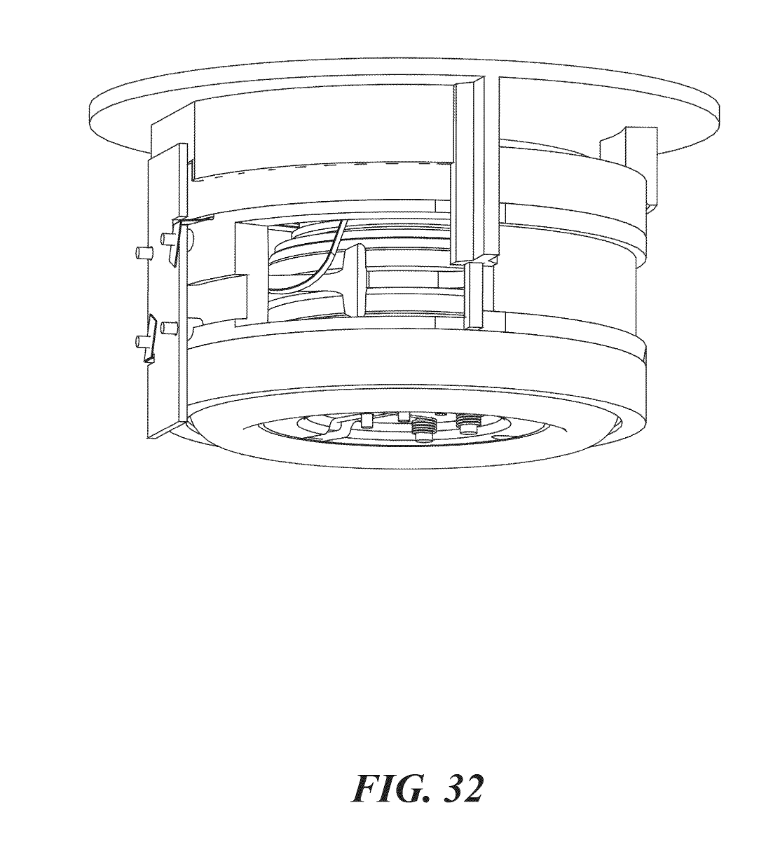

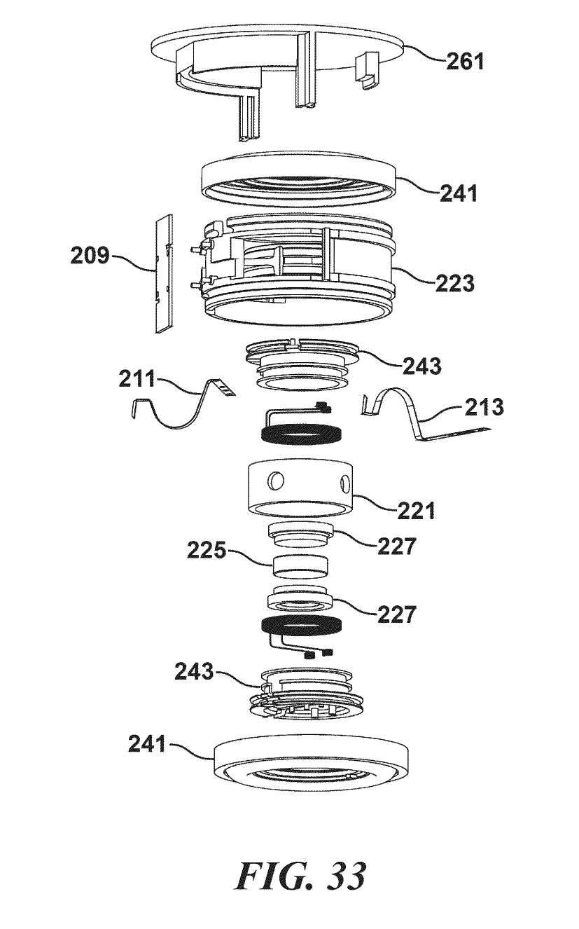

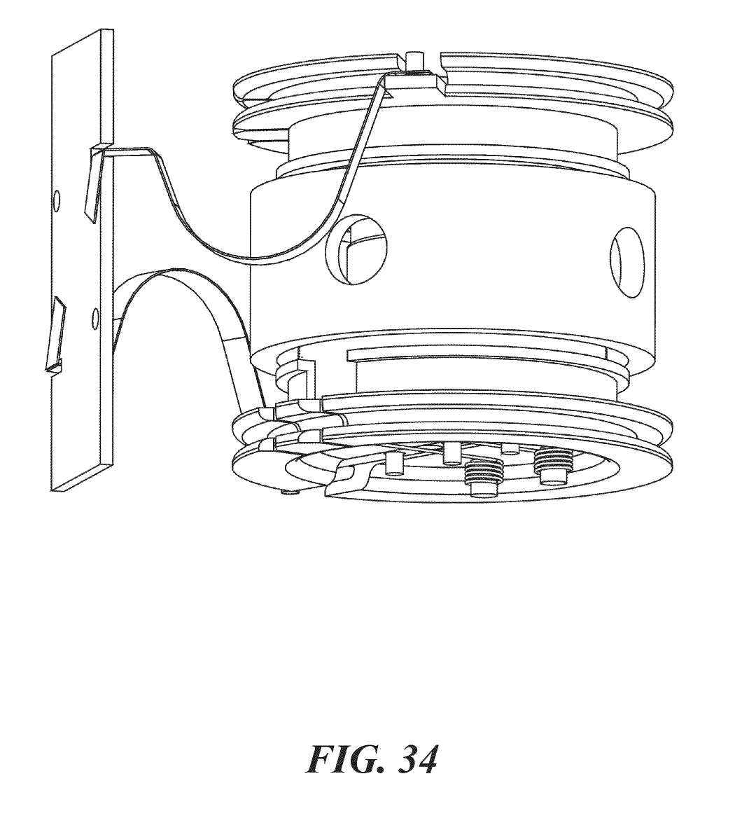

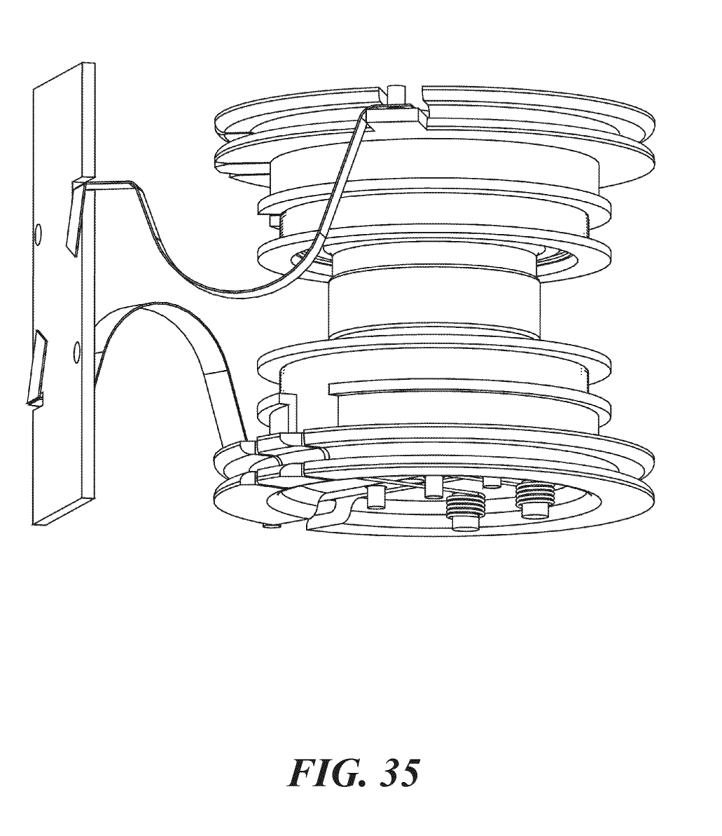

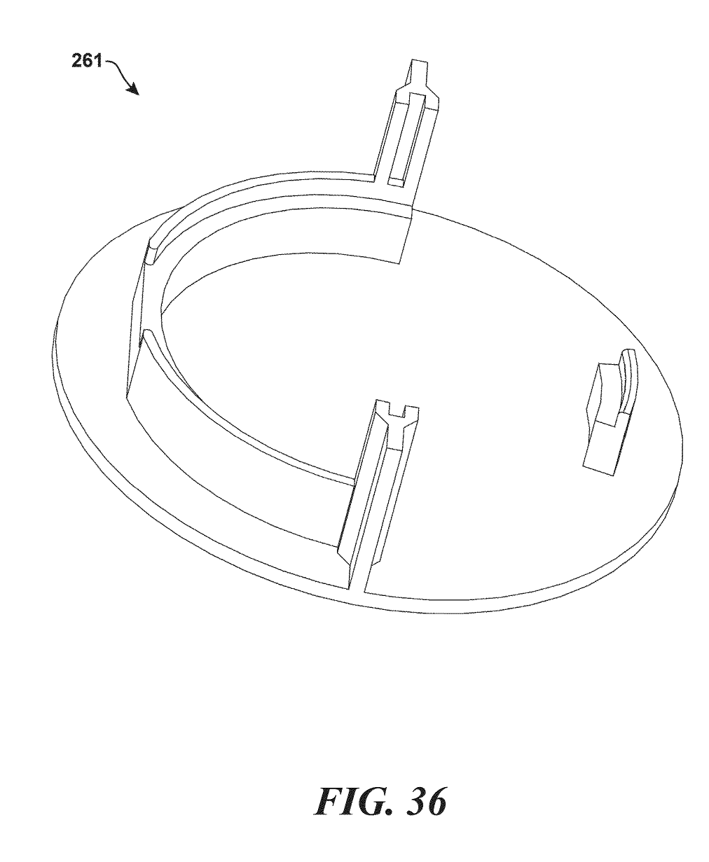

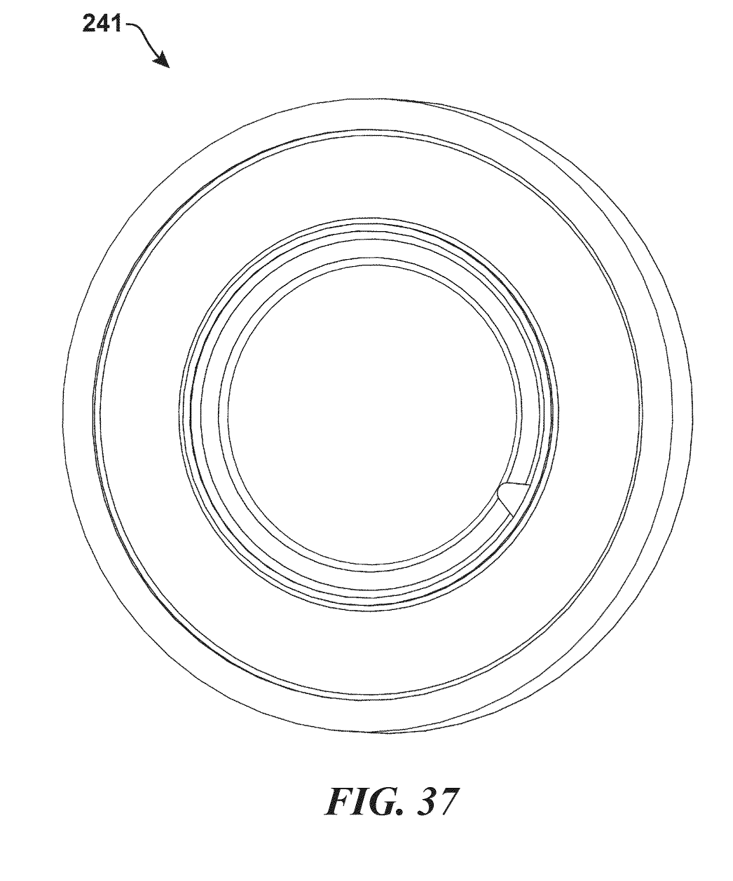

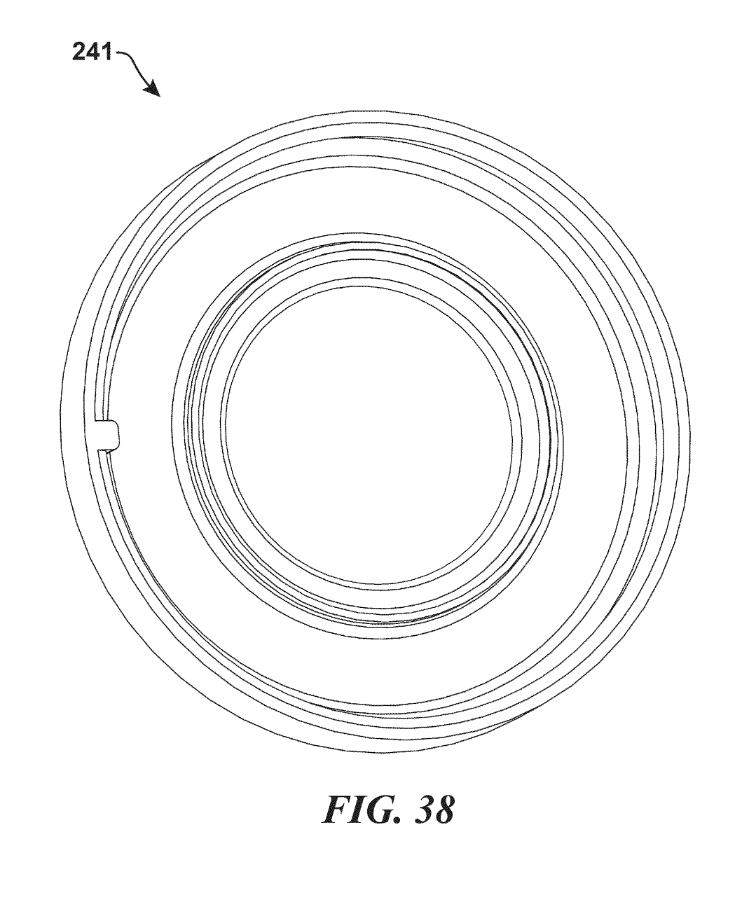

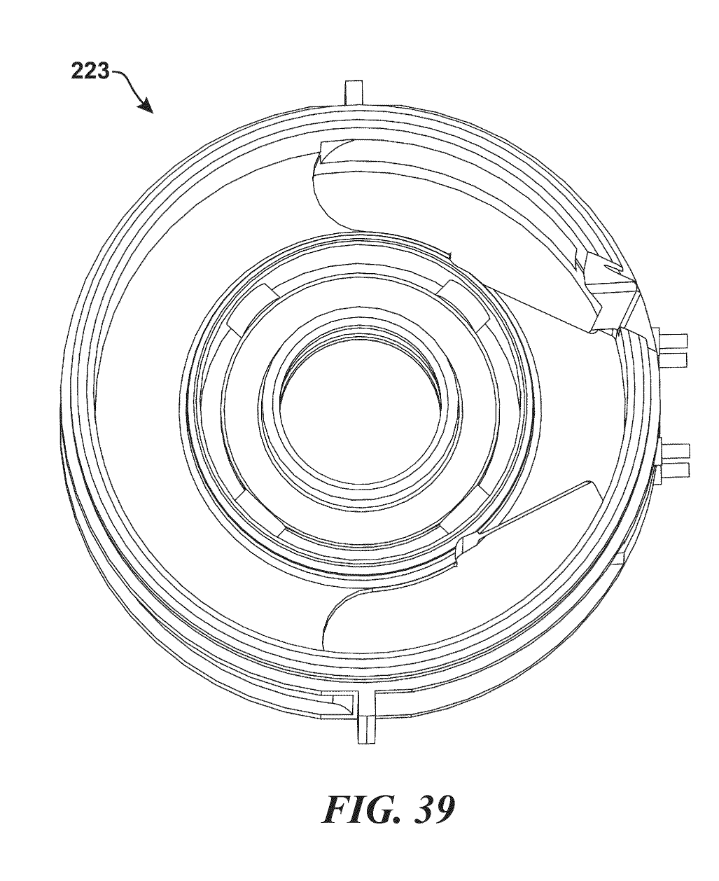

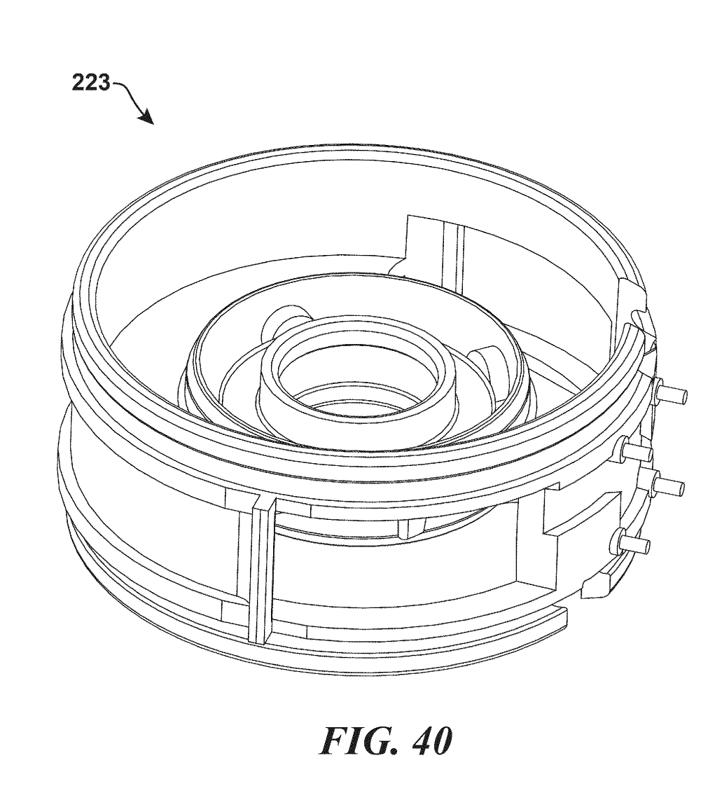

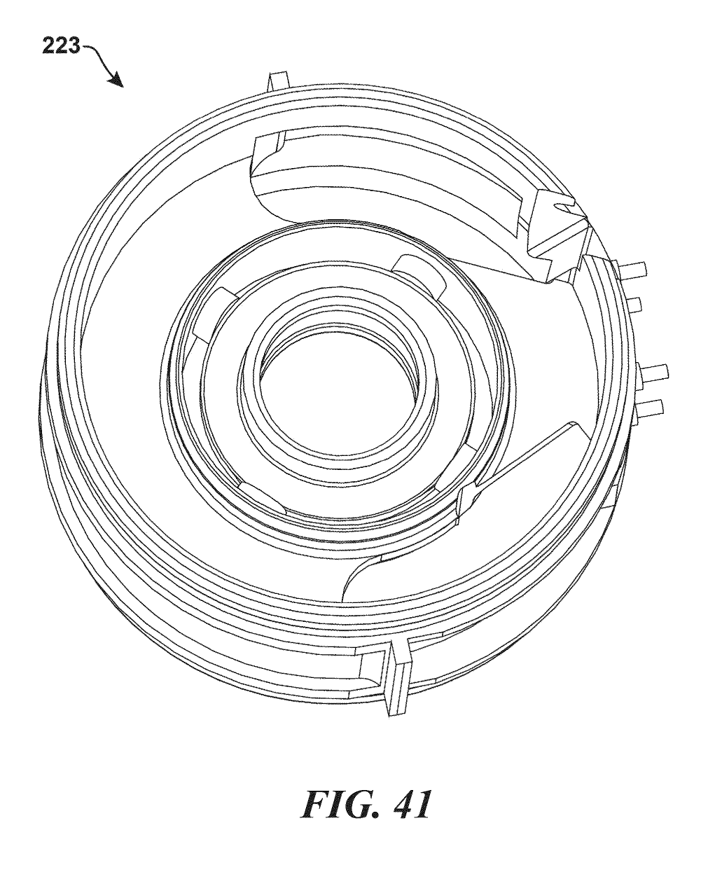

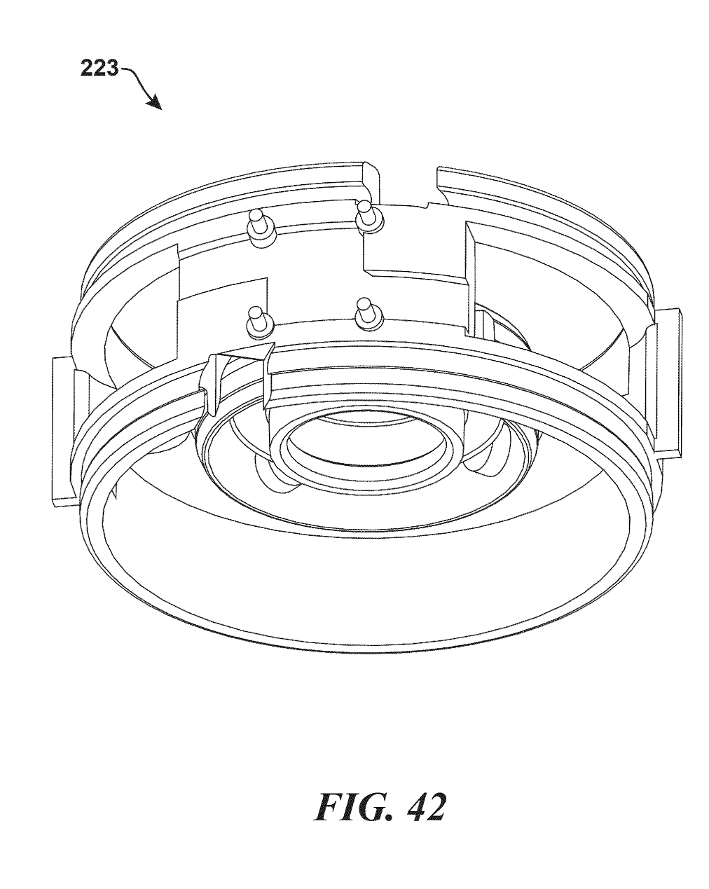

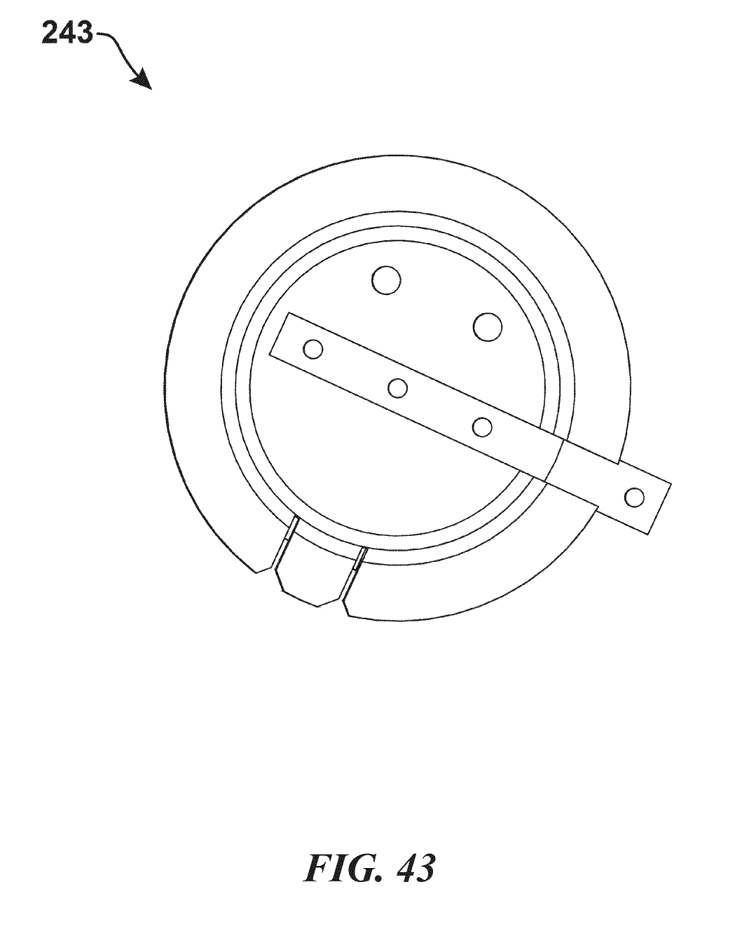

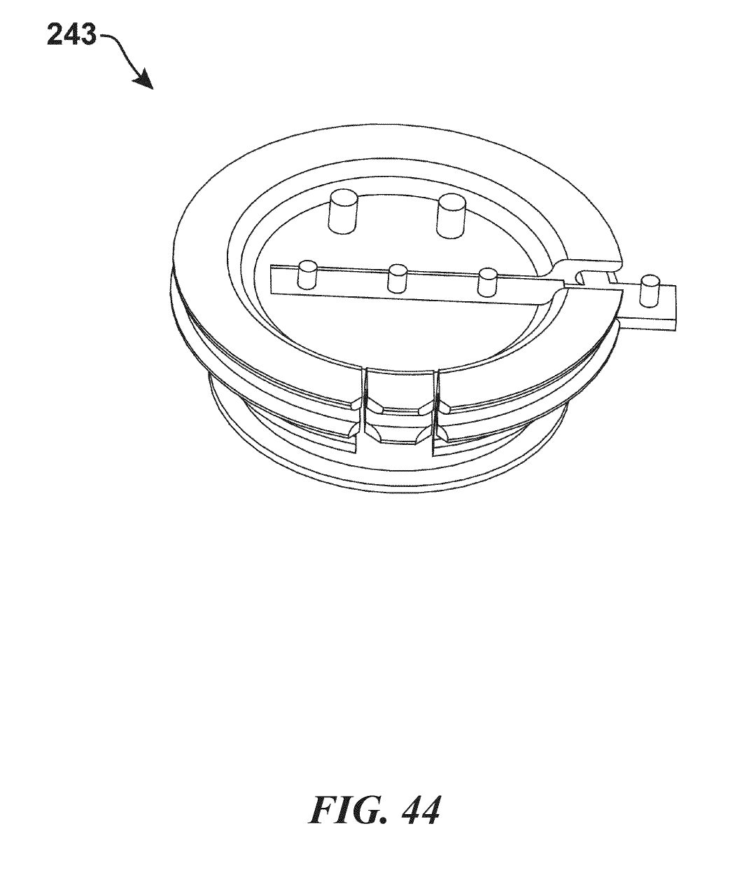

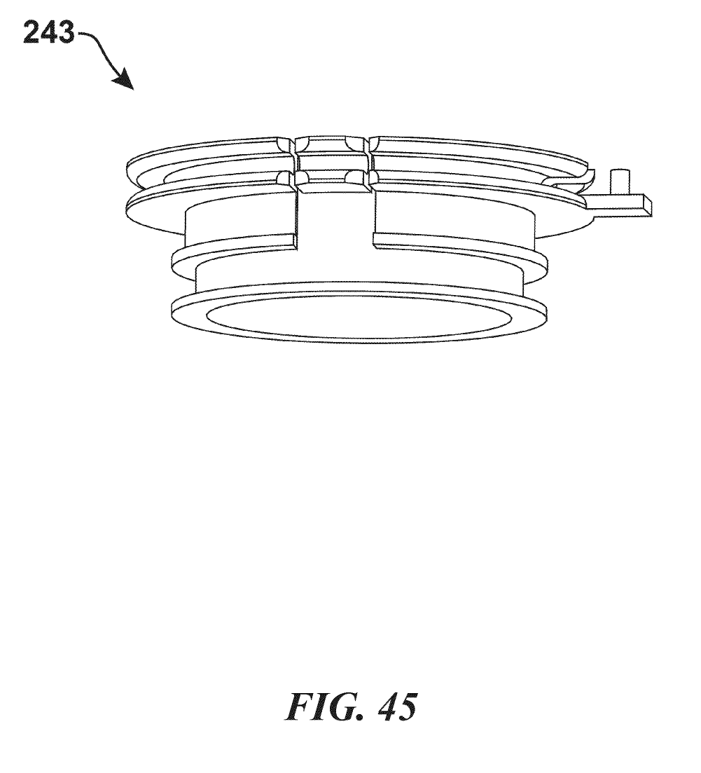

FIG. 2 depicts a first particular, non-limiting embodiment of an engine 201 for a synthetic jet ejector in accordance with the teachings herein. For reference, the complete engine 201 (equipped with a cover 261) is shown in FIG. 32, and an exploded view of the engine 201 is shown in FIG. 33. The engine 201 is shown in various states of disassembly in FIGS. 34-35, and the individual components of the engine 201 are depicted in FIGS. 36-45.

The engine 201 includes a chassis 203 with first 205 and second 207 synthetic jet actuators mounted in opposing ends thereof. An on-board PCB 209 or other controller, which may or may not be equipped with various components, controls the first 205 and second 207 synthetic jet actuators and is in electrical communication with them by way of first 211 and second 213 straight flexible connectors. The flexible connectors 211, 213 are preferably in the form of flexible circuits (also referred to herein as flexible circuitry), and may comprise a flexible plastic substrate such as, for example, a polyimide, a transparent and/or conductive polyester, or polyether ether ketone (PEEK). The circuitry may be formed on the flexible plastic substrate through screen printing the circuitry or by other suitable means using silver or another suitable conductor.

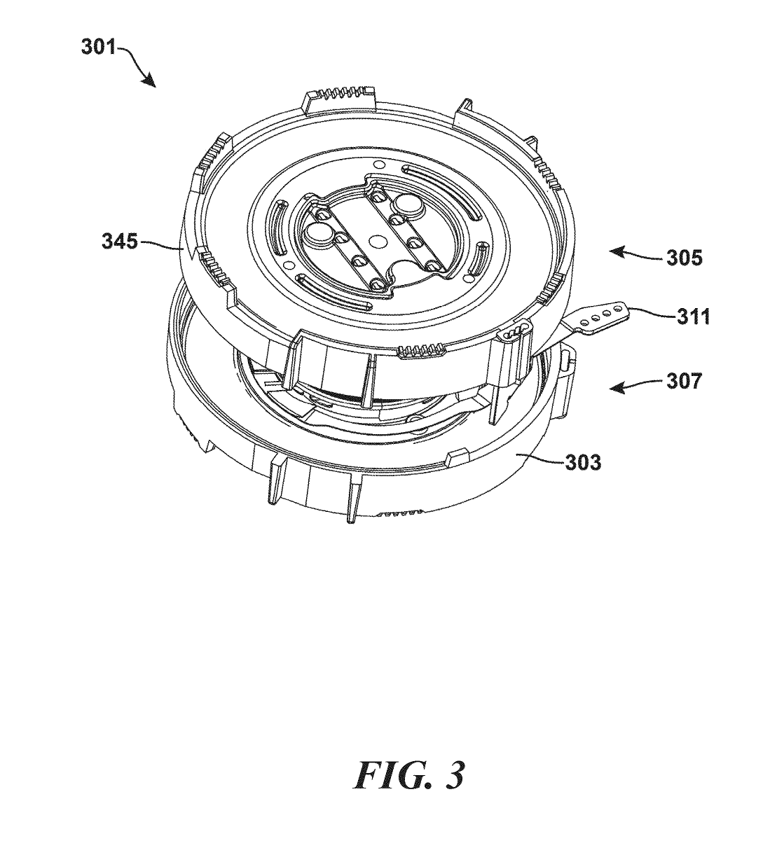

FIG. 3 depicts an embodiment of an engine 301 for a synthetic jet ejector from U.S. 2011/0198056 (Grimm et al.). Like the engine of FIG. 2, this engine 301 includes a chassis 303 with first 305 and second 307 synthetic jet actuators mounted in opposing ends thereof. However, there are several notable differences between the engines of FIGS. 2 and 3.

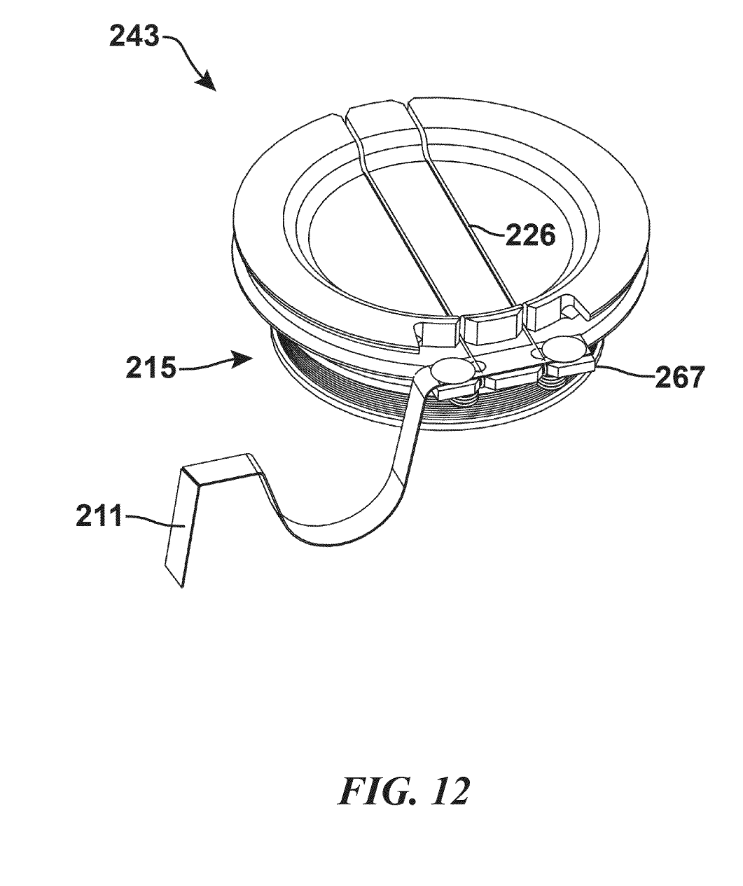

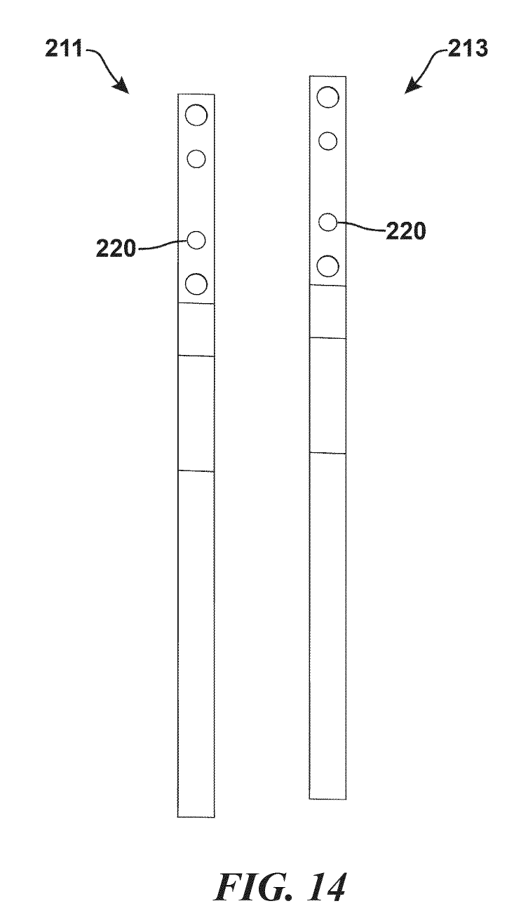

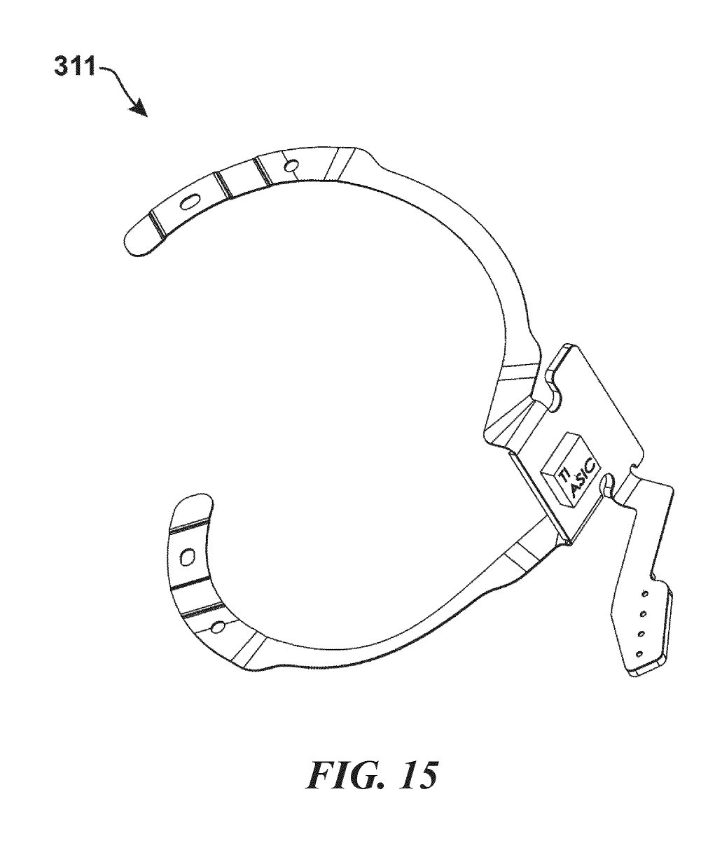

For example, the engine 301 of FIG. 3 uses a flex connector 311 (shown in greater detail in FIG. 15) which has a relatively complex shape with curved components. This flex connector 311 is more difficult and expensive to manufacture because of its shape. This flex connector 311 also complicates assembly, because it requires attachment at three different points. By contrast, the engine 201 of FIG. 2 utilizes first 211 and second 213 flexible connectors (shown in greater detail in FIGS. 12 and 14) which are straight and essentially rectangular in shape, and which require only two points of attachment. Moreover, if one of the first 211 and second 213 flexible connectors becomes damaged during manufacture or use, it can be replaced without having to disturb the other connector.

The use of first 211 and second 213 flexible connectors also adds considerable flexibility to engine manufacture and design. For example, various connection configurations may be used to achieve electrical connection between the on-board PCB 209 (see FIG. 2) and the terminal ends of the metal (preferably copper wire) coil 215.

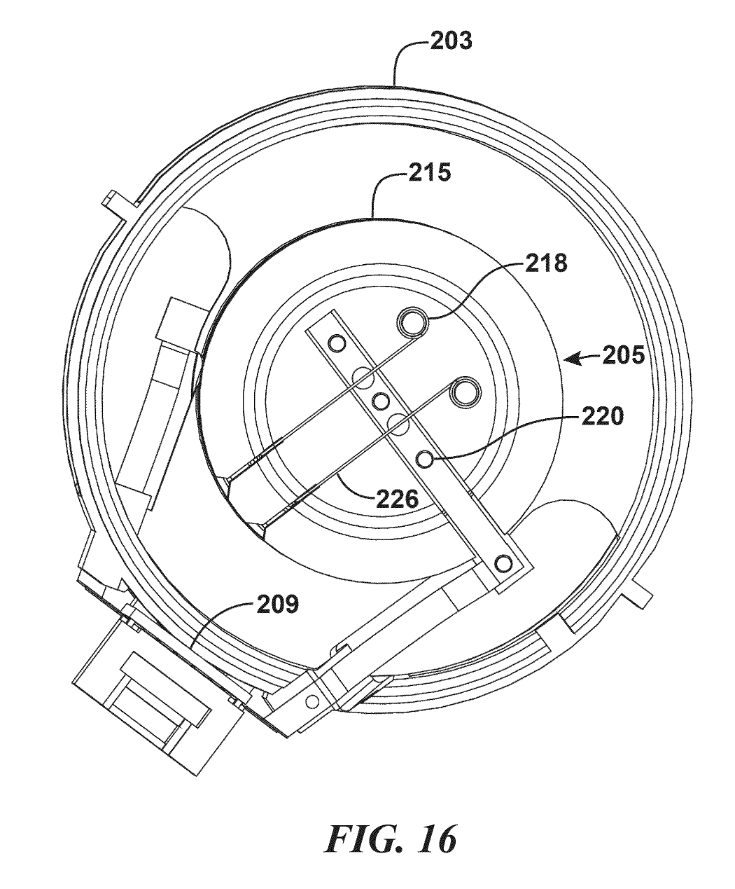

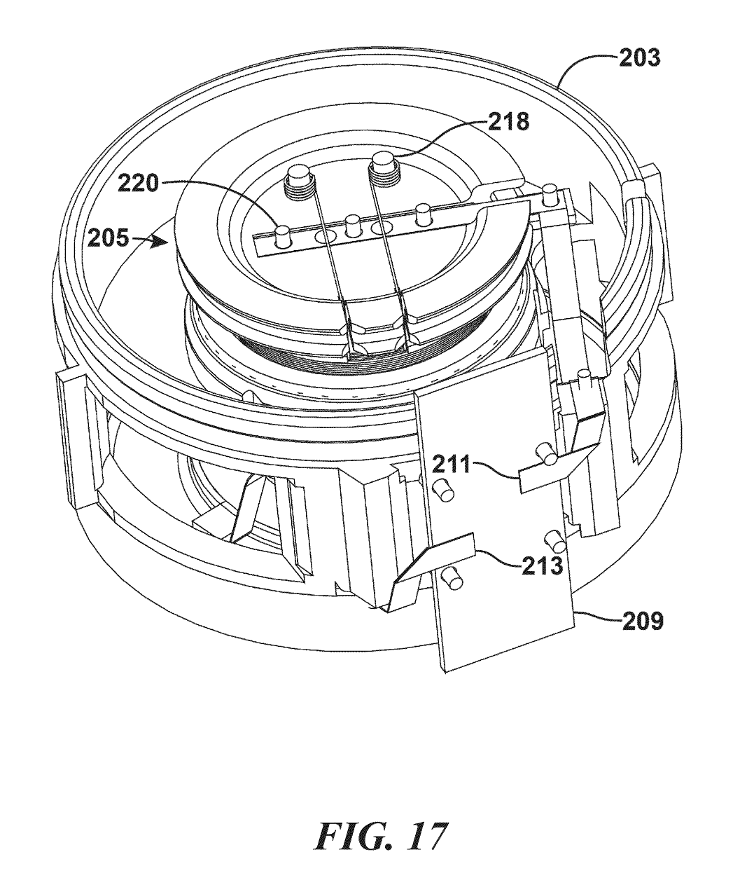

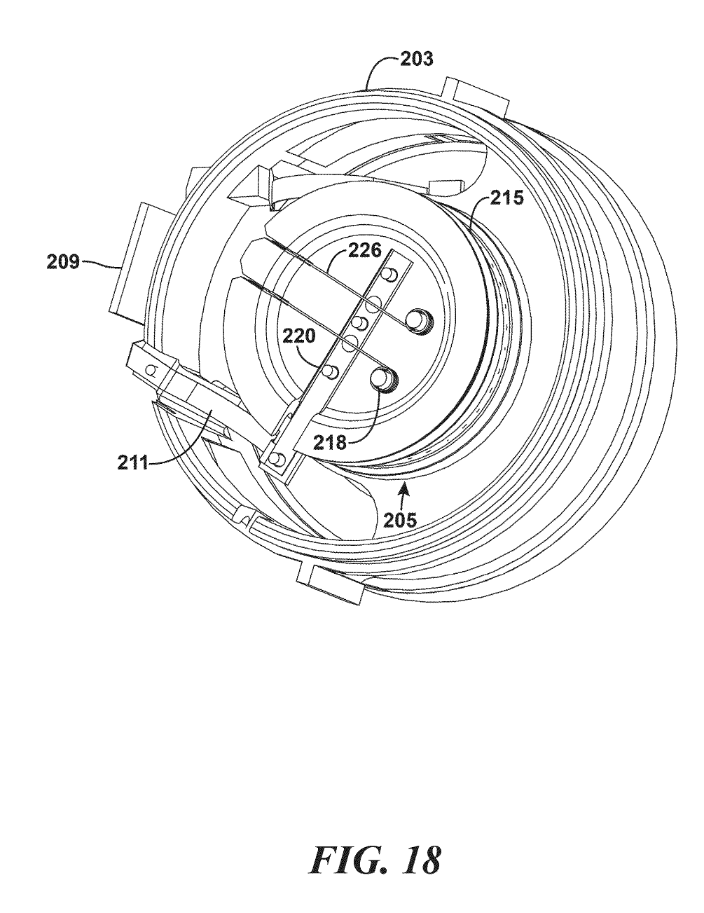

A first embodiment of such a connection configuration is shown in FIGS. 16-18. As seen therein, the coil 215 of each actuator 205, 207 is equipped with a pair of terminals 218 disposed on the top of the coil 215, and around which the terminal portions of the coil wire are wound. The top of each actuator 205, 207 is further equipped with a series of protrusions 220 that engage a series of corresponding perforations 222 in the first 211 and second 213 flexible connectors. These protrusions 220 thus serve to hold the first 211 and second 213 flexible connectors in place and to key them in the proper orientation with respect to the corresponding first 205 and second 207 synthetic jet actuators. Electrical connection between the first 211 and second 213 flexible connectors and a terminal portion of the coil wire 226 from their corresponding actuator coils 215 may then be achieved by soldering, spot welding, through the use of a conductive adhesive, with a clamp, or by other suitable means for making electrical contact as are known to the art.

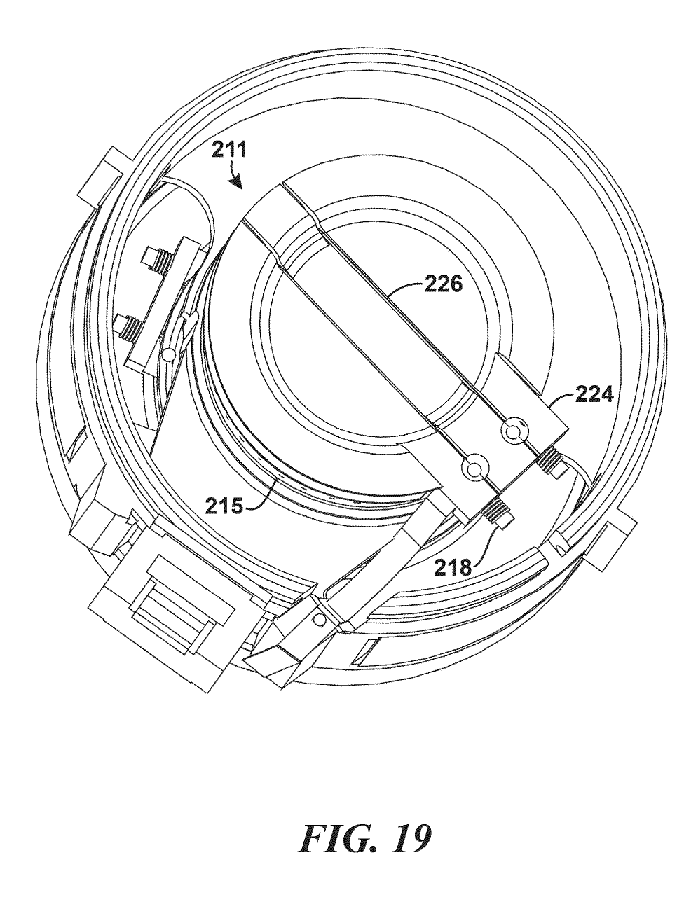

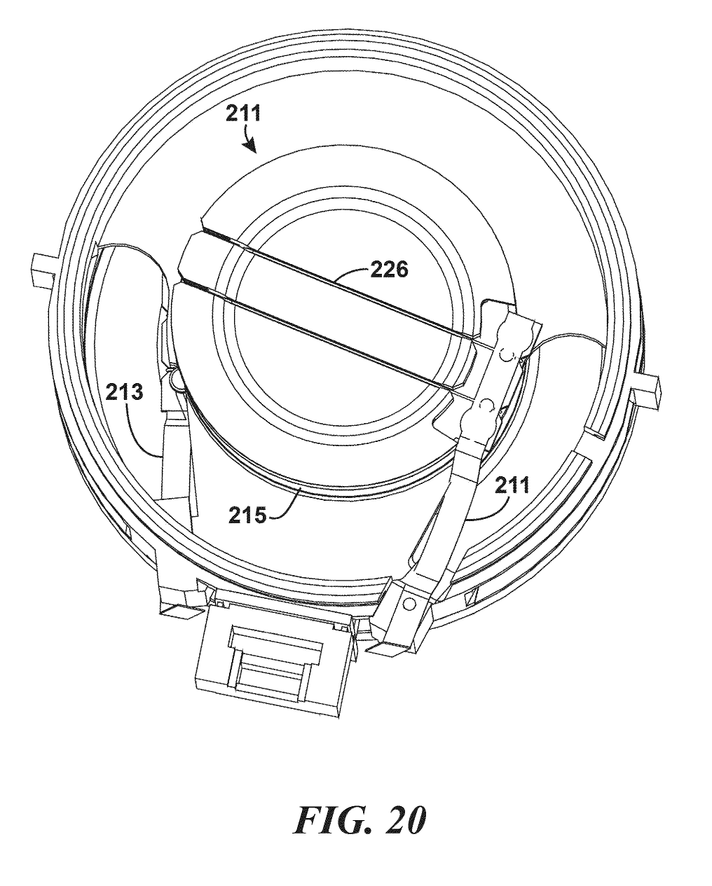

Second and third embodiments of such connection configurations are shown in FIGS. 19 and 20, respectively. These embodiments are similar in most respects to the embodiment of FIGS. 16-18. Thus, the embodiment of FIG. 19 differs from the embodiment of FIGS. 16-18 primarily in that the terminals 218 are disposed on the side of the actuator 205, 207. The first 211 and second 213 flexible connectors in this embodiment are secured in place by way of a terminal plate 224.

The embodiment of FIG. 20 differs from the embodiment of FIG. 19 primarily in that the first 211 and second 213 flexible connectors are disposed over terminal portions of the coil wire 226 and are used to secure the terminal portions of the coil wire 226 in place. Consequently, no terminals are required in this embodiment.

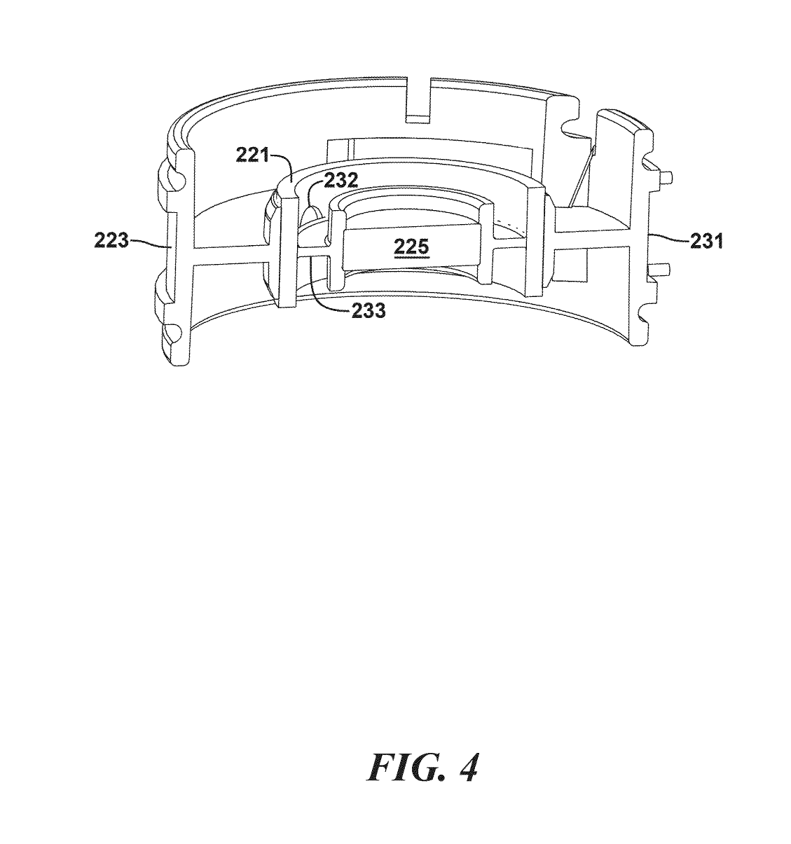

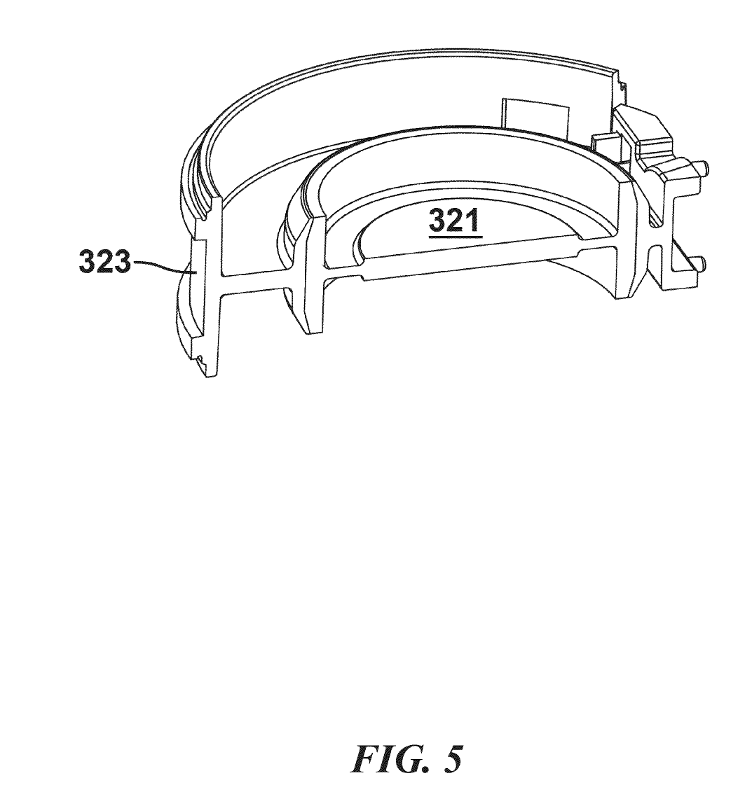

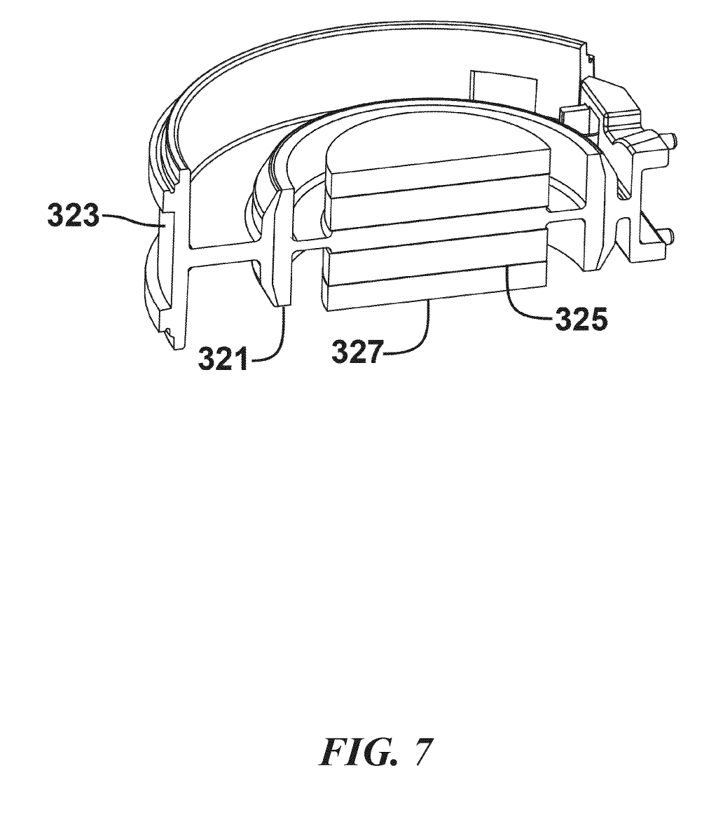

Another difference between the engines of FIGS. 2 and 3 may be appreciated with respect to FIGS. 4-7. As seen in FIG. 5, the motor 301 of FIG. 3 has a back iron 321 around which the chassis 323 is insert-molded. As seen in FIG. 7, a magnet 325 and a plate 327 is disposed on each side of the back iron 321. The manufacture of this assembly thus requires four components, and four adhesive bonds.

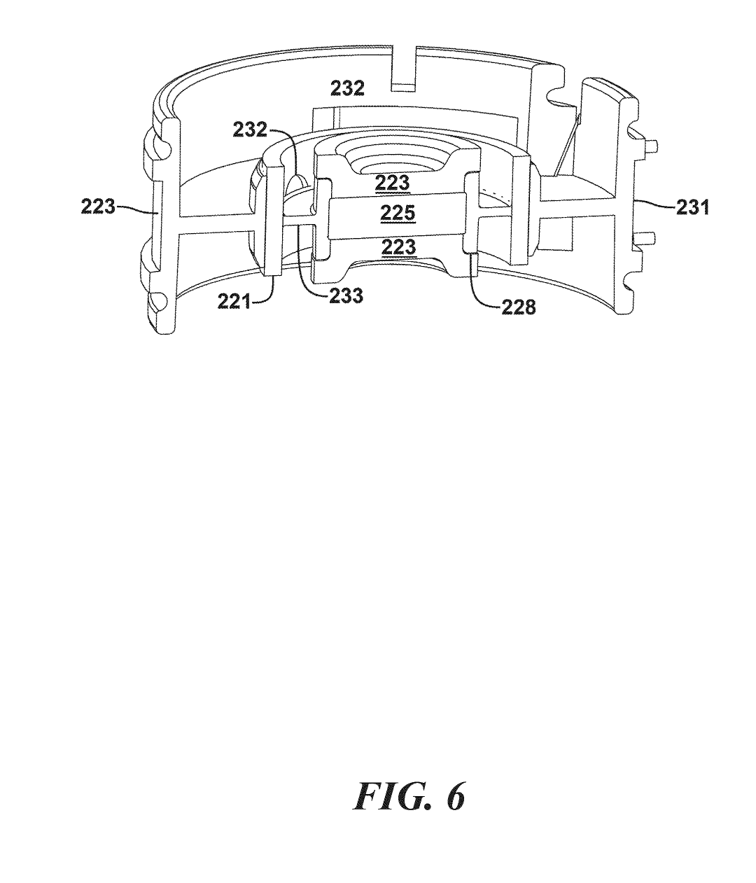

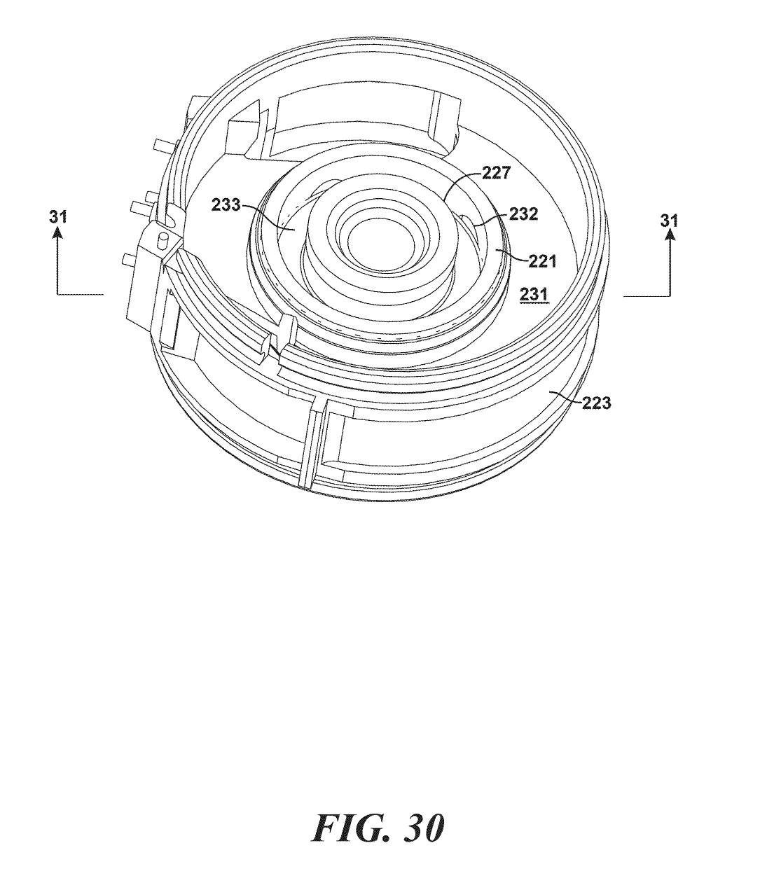

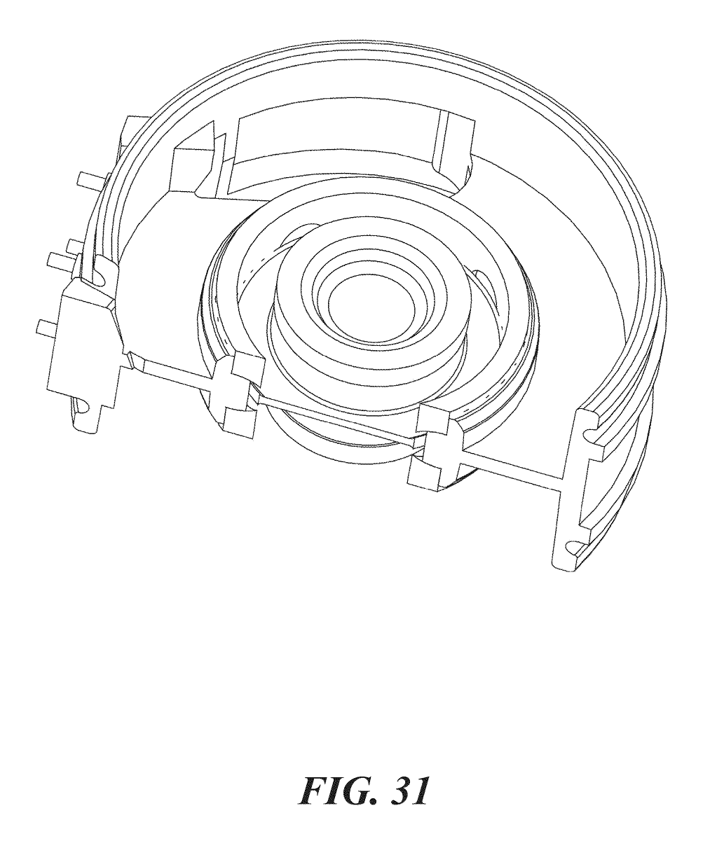

As seen in FIGS. 4 and 6, the motor 201 of FIG. 2 also has a back iron 221 around which the chassis 223 is insert-molded. However, this back iron 221 is equipped with a plurality of apertures 232 through which the molding composition extends (see FIGS. 30-31), thereby securely locking the back iron 221 into place.

Moreover, the chassis 223 is formed such that it has a first component 231 disposed outside of the back iron 221, and a second component 233 formed inside of the back iron 221. As best seen in FIG. 6, the second component 233 of the chassis 223 is insert-molded around the magnet 225, and preferably also around the plates 227. This causes the second component to extend around the edges of the magnet 225 and slightly over the major surfaces thereof, thus holding the magnet 225 securely in place. Moreover, the plates 227 are equipped with an annular groove 236 on the bottom so that they are held firmly in place in the transverse direction by the resulting lip of the wall of the second component 233 (the plates are held in place in the direction orthogonal to the transverse direction by magnetic attraction).

As a result of the foregoing construction of the back iron 221 and magnet 225, the engine 201 of FIG. 2 does not require any adhesive bonds to hold the back iron 221, magnet 225 and plates 227 in place. Moreover, the use of a centralized magnet 225 in the design of this engine requires only a single magnet 225, rather than the two magnets 325 utilized in the engine 301 of FIG. 3.

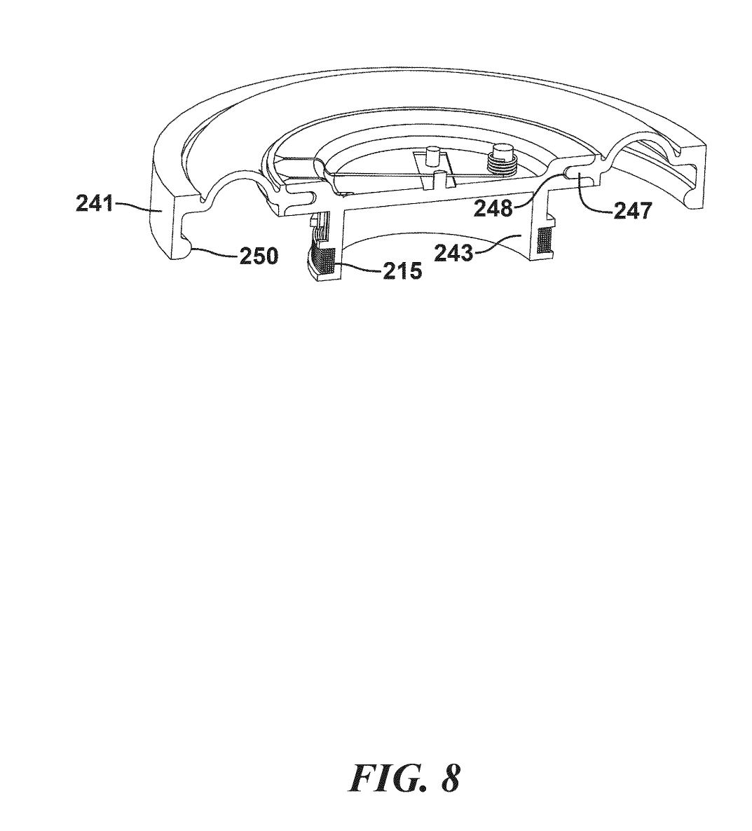

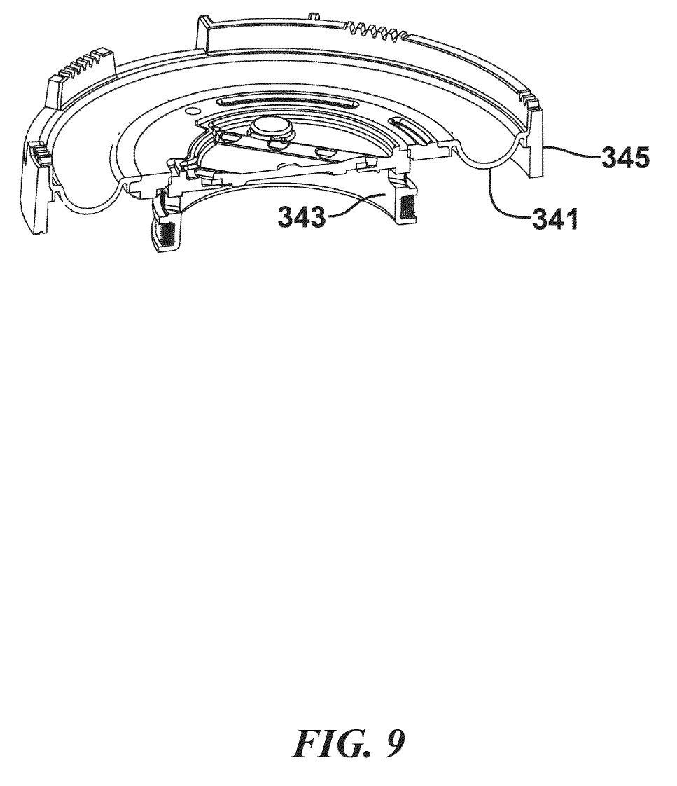

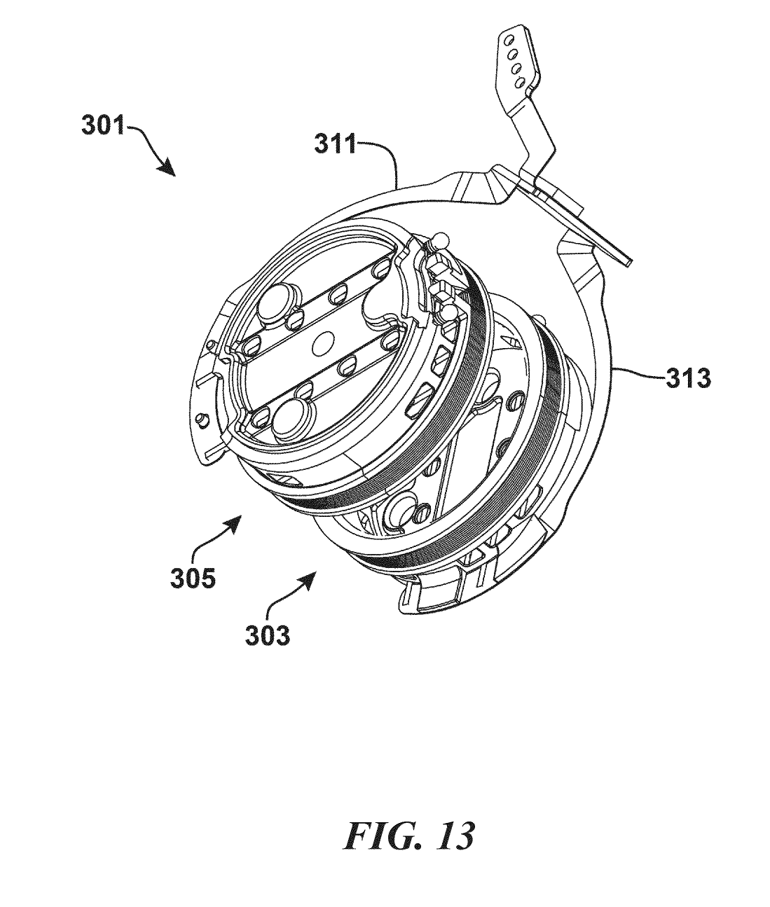

Another difference between the engines of FIGS. 2 and 3 may be appreciated with respect to FIGS. 8-9. As seen in FIG. 9, the motor 301 of FIG. 3 has a diaphragm 341 which is formed by a two-shot insert molding process, and which is secured to the bobbin 343 and the frame 345 of the motor 301 by ultrasonic welding (USW). For reference, FIG. 13 shows the engine 301 with the frames 345 removed.

By contrast, the motor 201 of FIG. 2 is equipped with a diaphragm 241 which has an inner circumferential ridge 247 that releasably engages a complimentary-shaped circumferential groove 248 in the bobbin 243, and an outer ridge 250 that releasably engages an opposing and complimentary-shaped circumferential groove in the chassis 223. As a result of this construction, the diaphragm can be readily snapped into place (possibly with stretching) over the bobbin 243 and chassis 203. Hence, this design simplifies the design of the motor assembly by doing away with the need for a frame 345 (see FIG. 9), and simplifies the manufacturing process by eliminating two ultrasonic welding steps. Moreover, because it is readily removable, the diaphragm 241 in the resulting motor may be readily replaced if it becomes worn or damaged.

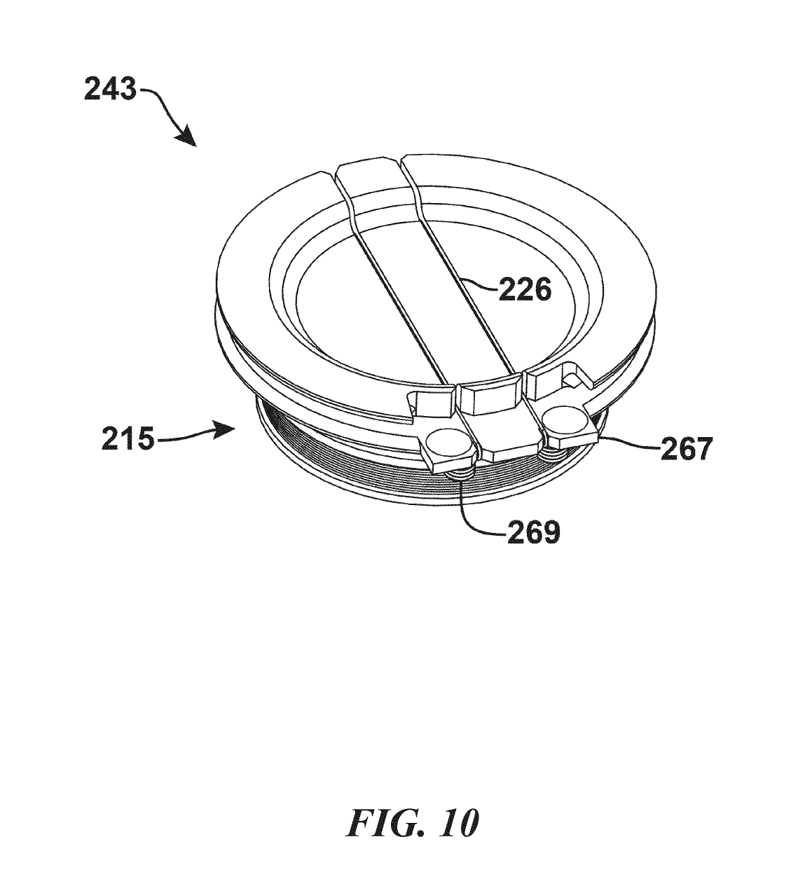

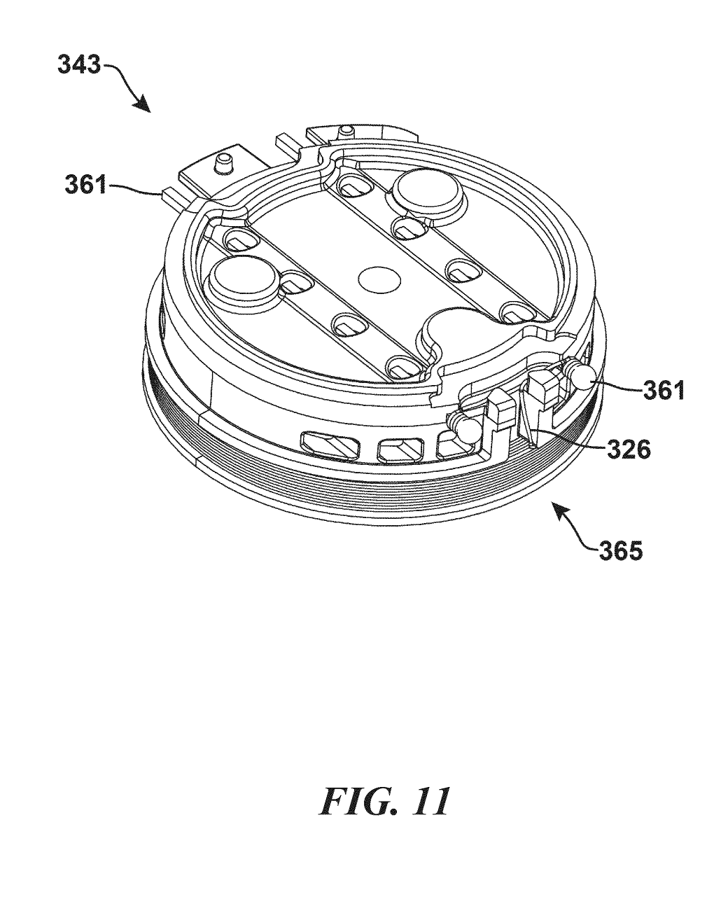

Another difference between the engines of FIGS. 2 and 3 may be appreciated with respect to FIGS. 10-11. As seen in FIG. 11, the bobbin 343 in the motor 301 of FIG. 3 is equipped with dual terminal pins 361 around which the terminal portions of the (preferably copper) wire 363 of the voice coil 365 are wound.

As seen in FIG. 10, the need for the terminal pins 361 of FIG. 11 is eliminated by the design of the bobbin 243 in the motor 201 of FIG. 2. Instead, the bobbin 243 is equipped with a platform 267 having first and second protrusions 269 thereon around which the terminal portions of the (preferably copper) wire 226 of the voice coil 215 are wound.

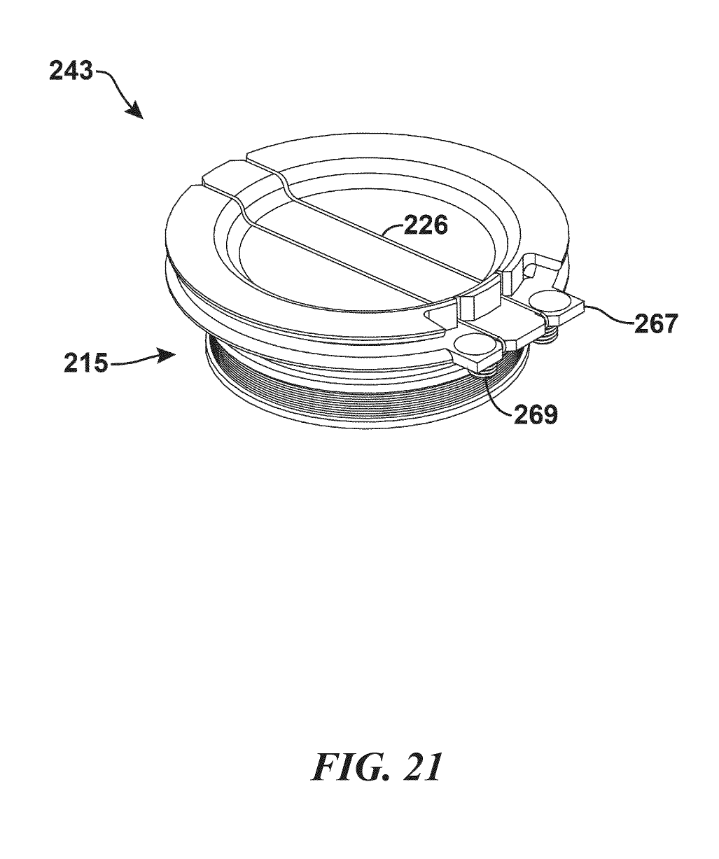

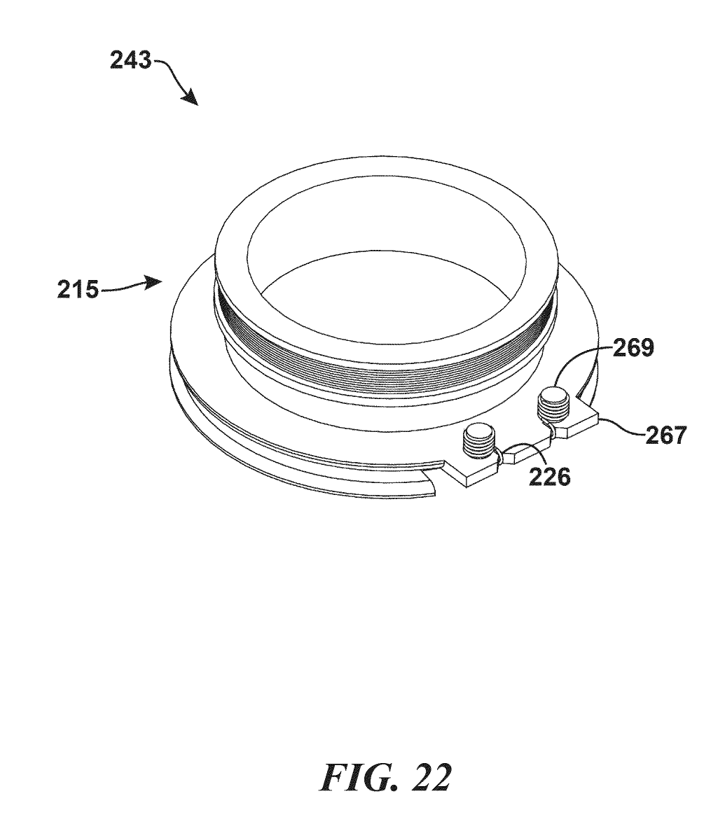

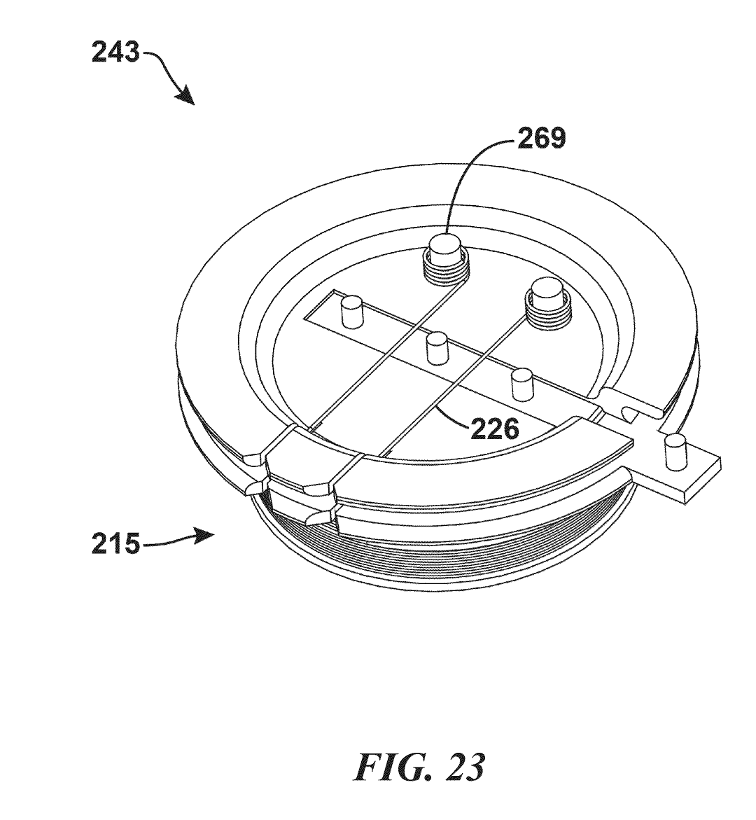

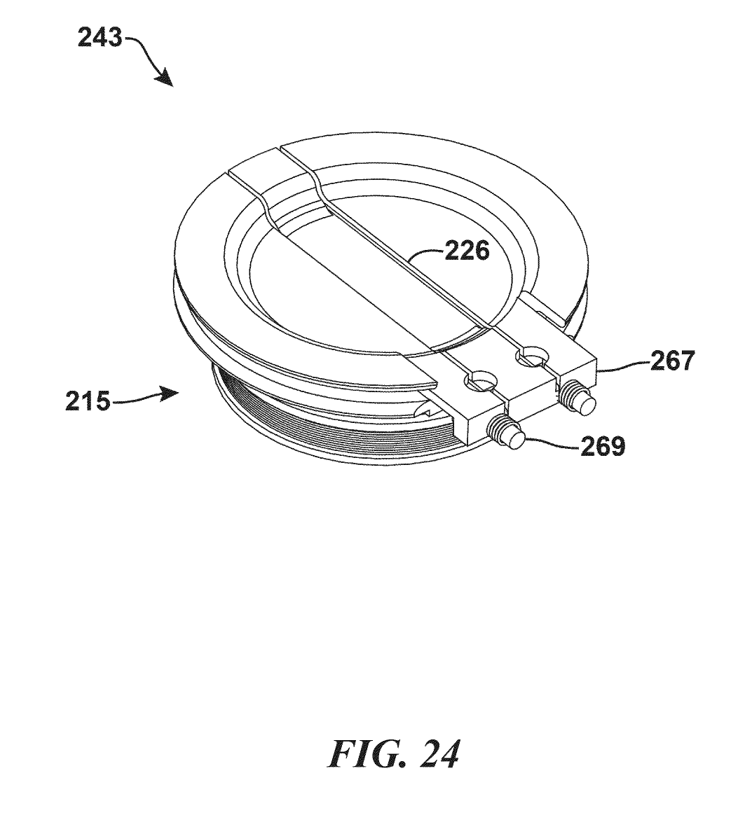

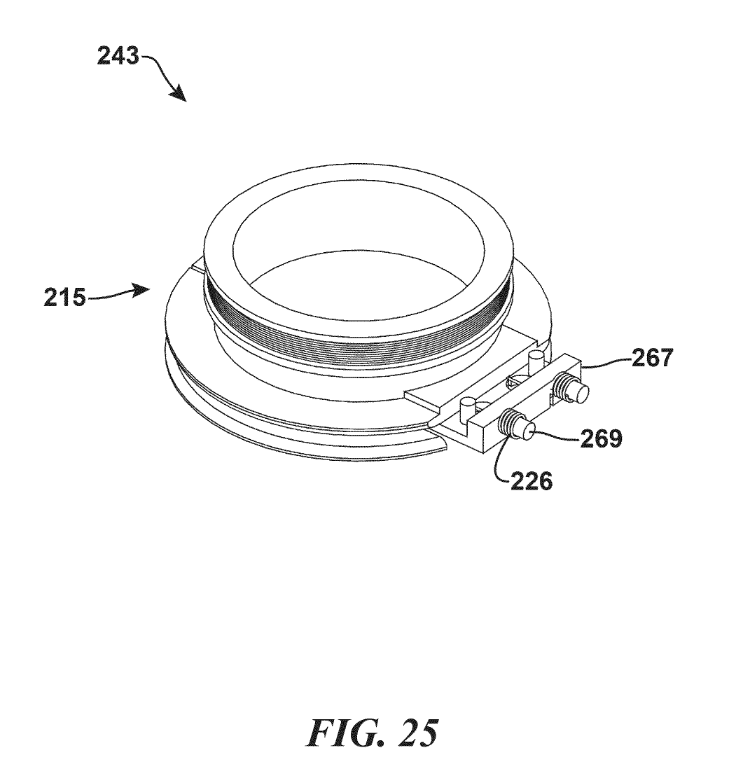

Various configurations of the start/finish leads may be utilized in the coils of the engines of the synthetic jet ejectors disclosed herein. For example, the bobbin 243 may utilize bottom terminations as shown in FIGS. 21-22, top terminations as shown in FIG. 23, or side terminations as shown in FIGS. 24-25. Preferably, the wire start/finish leads are wound around plastic protrusions or terminal posts. The terminations are preferably secured through the use of a suitable adhesive or by melting plastic in a heat-stake operation, though other suitable processes may be utilized as well. These processes may be implemented as part of the winding operation, or may be performed off-line manually or in a separate machine.

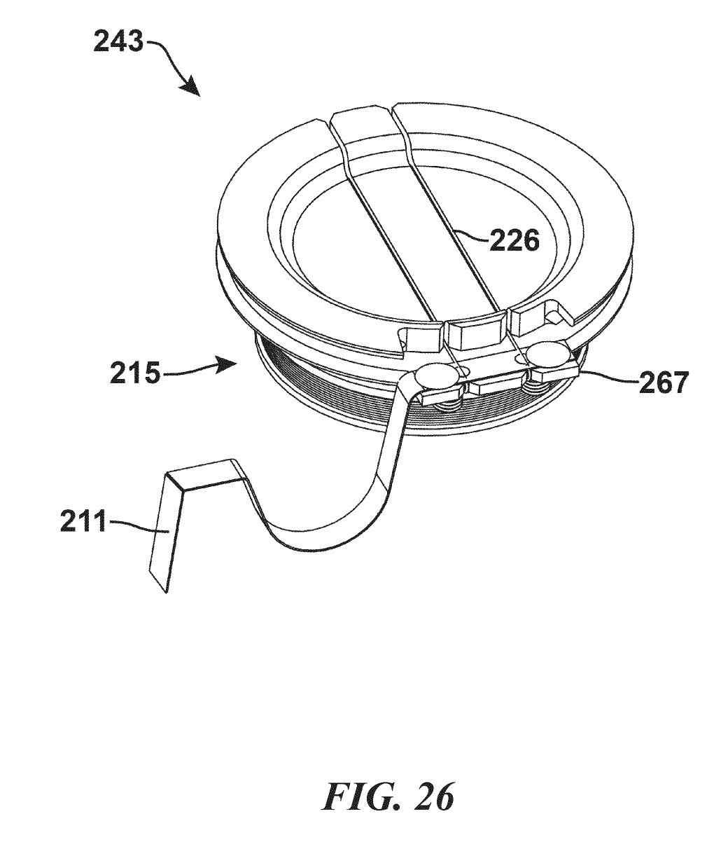

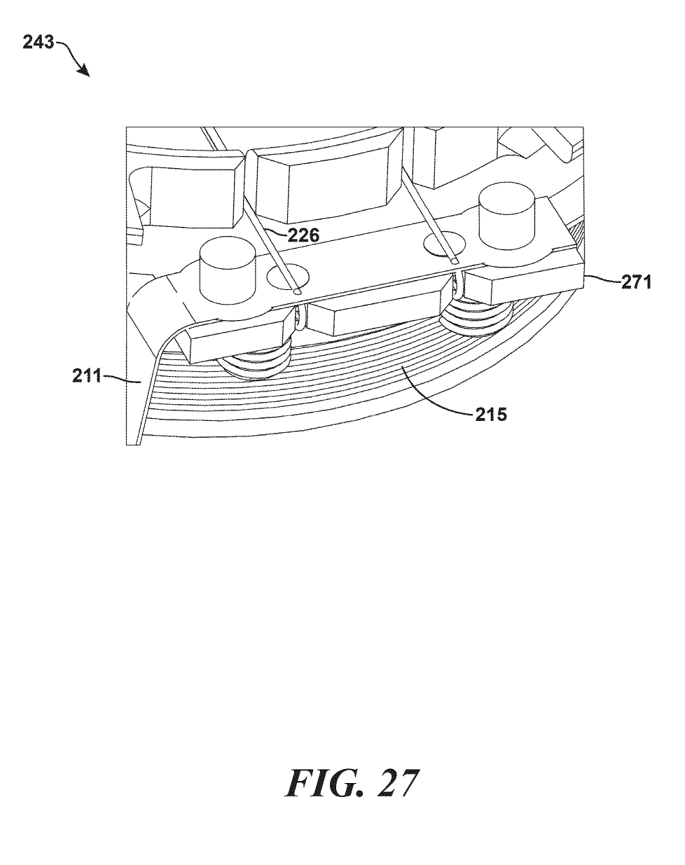

As shown in FIGS. 26-27, after the wire 226 is wound on the bobbin 243, a flexible connector 211 may be placed under the terminal portions of the wire 226, after which the terminal portions of the wire 226 may be connected to the connection pads on the flex connectors 211 and 213. Such connections may be achieved by soldering or through thermo-compression.

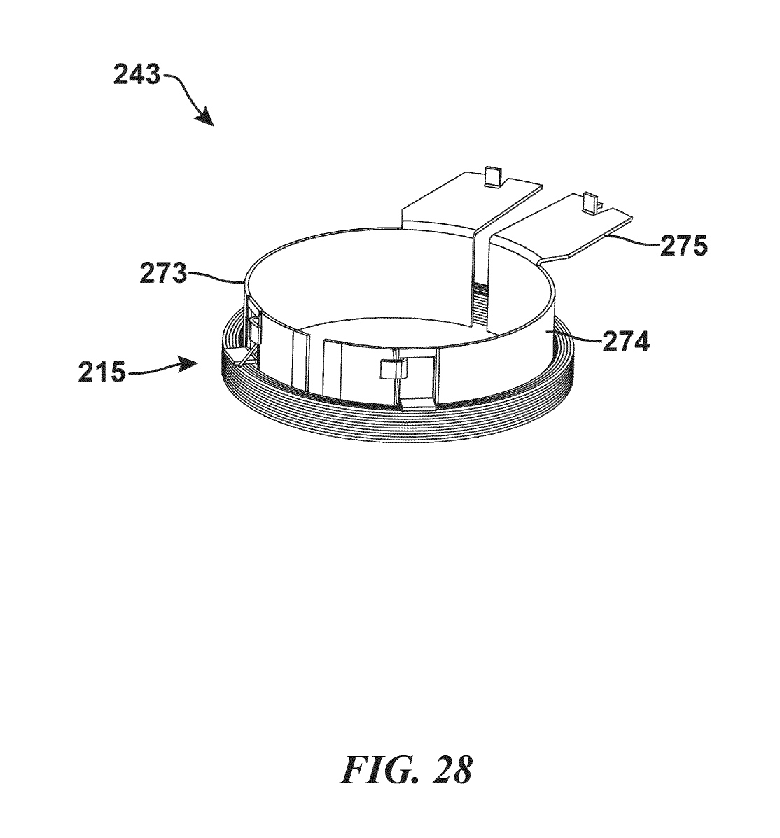

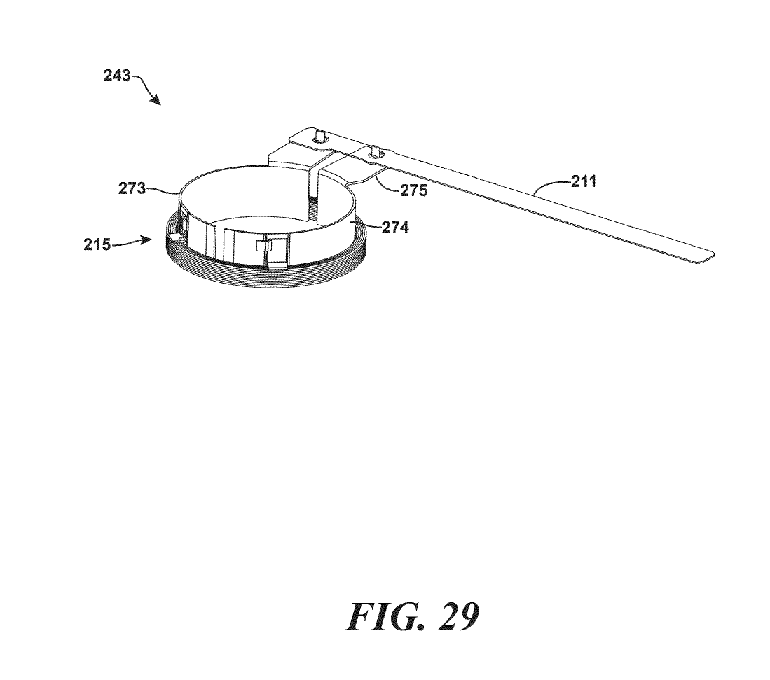

As seen in FIGS. 28-29, the bobbin 243 is preferably equipped with two (preferably aluminum) coil formers 273, 274 which are preferably mirror images of each other. A flange 275 is provided on each of the coil formers 273, 274 so that the start/finish leads may be terminated under the flanges 275 in the coil formers 273, 274 via resistance welds. As seen in FIG. 29, connection of the flex connectors 211 occurs after, and independent of, the winding process.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

1. A synthetic jet ejector, comprising:
a chassis;
first and second opposing synthetic jet actuators mounted in said chassis; and
a controller which controls said first and second synthetic jet actuators and which is in electrical contact with said first and second synthetic jet actuators by way of flexible circuitry, the controller including a PCB mounted on an exterior surface of said chassis.

2-3. (canceled)

4. The synthetic jet ejector of claim 1, wherein said controller is a PCB, and further comprising first and second distinct flexible circuits, wherein each of said flexible circuits has a first end which is in electrical contact with said PCB, and a second end which is in electrical contact with one of said first and second synthetic jet ejectors.

5. The synthetic jet ejector of claim 4, wherein said first and second flexible circuits are essentially straight.

6-19. (canceled)

20. The synthetic jet ejector of claim 1, wherein each of said first and second synthetic jet actuators comprises a bobbin and a diaphragm, wherein said bobbin has a circumferential groove on one end thereof, and wherein said diaphragm has a complimentary-shaped circumferential protrusion which releasably engages said circumferential groove.

21-23. (canceled)

24. The synthetic jet ejector of claim 1, wherein each of said first and second synthetic jet actuators comprises a bobbin having a coil of wire wound about a surface thereof, wherein said coil of wire has first and second ends, wherein each bobbin comprises a platform which extends from one side thereof, wherein said platform comprises first and second protrusions, wherein said first end of said coil of wire is wrapped around said first protrusion, and wherein said second end of said coil of wire is wrapped around said second protrusion.

25-31. (canceled)

32. A synthetic jet ejector, comprising:
a chassis;
at least one synthetic jet actuator supported on said chassis; and
a back iron having an essentially annular wall with a plurality of holes therein;
wherein said chassis extends through said plurality of holes.

33. The synthetic jet ejector of claim 32, wherein said holes are evenly spaced about the circumference of said wall.

34. The synthetic jet ejector of claim 32, wherein said chassis comprises a first chassis component disposed outside of the wall of said back iron, and a second chassis component disposed inside the wall of said back iron.

35. The synthetic jet ejector of claim 34, further comprising a third chassis component which joins said first and second chassis components together and which extends through said holes in said wall.

36-39. (canceled)

40. The synthetic jet ejector of claim 32, further comprising a magnet; wherein said chassis comprises a first chassis component disposed outside of the wall of said back iron, and a second chassis component disposed inside the wall of said back iron, and wherein said magnet is housed within said second chassis component.

41. The synthetic jet ejector of claim 40, wherein said magnet is cylindrical in shape, and wherein said second chassis component contains an annular indentation which is complimentary in shape to a portion of the exterior shape of said magnet.

42. The synthetic jet ejector of claim 41, wherein said indentation fixes said magnet in place within said second chassis component.

43. The synthetic jet ejector of claim 40, wherein said magnet has first and second major surfaces, and further comprising first and second plates disposed, respectively, on said first and second major surfaces.

44. The synthetic jet ejector of claim 43, wherein said second chassis component comprises an annular wall having first and second opposing edges, wherein said magnet is disposed within said annular wall, and wherein each of said first and second plates comprises an annular groove which releasably engages one of said opposing edges of said annular wall.

45-47. (canceled)

48. A synthetic jet ejector, comprising:
a bobbin; and
a diaphragm;
wherein said bobbin has a circumferential groove on one end thereof, and wherein said diaphragm has a complimentary-shaped circumferential protrusion which releasably engages said circumferential groove.

49-50. (canceled)

51. A synthetic jet ejector, comprising:
a back iron;
a chassis having a first chassis component disposed outside of the wall of said back iron, and a second chassis component disposed inside the wall of said back iron; and
a magnet supported on said second chassis component;
wherein said magnet is cylindrical in shape, and wherein said second chassis component contains an annular indentation which is complimentary in shape to a portion of the exterior shape of said magnet.

52. The synthetic jet ejector of claim 51, further comprising at least one synthetic jet actuator supported on said chassis.

53. The synthetic jet ejector of claim 51, wherein said back iron has an essentially annular wall with a plurality of holes therein, and wherein said chassis extends through said plurality of holes.

54. The synthetic jet ejector of claim 53, further comprising a third chassis component which joins said first and second chassis components together and which extends through said holes in said wall.

55. The synthetic jet ejector of claim 51, wherein said indentation fixes said magnet in place within said second chassis component.

56. The synthetic jet ejector of claim 51, wherein said magnet has first and second major surfaces, and further comprising first and second plates disposed, respectively, on said first and second major surfaces.

57. The synthetic jet ejector of claim 56, wherein said second chassis component comprises an annular wall having first and second opposing edges, wherein said magnet is disposed within said annular wall, and wherein each of said first and second plates comprises an annular groove which releasably engages one of said opposing edges of said annular wall.

58. A method for making a synthetic jet ejector, comprising:
arranging a back iron and magnet within a mold, wherein said back iron has an annular wall with a plurality of apertures therein, and wherein said magnet is disposed within said annular wall; and
molding a chassis around said back iron and magnet such that the chassis supports the back iron and the magnet and such that the molding material extends through the apertures in the annular wall.

59. The method of claim 58, wherein the molded chassis has a first chassis component disposed outside of the wall of said back iron, and a second chassis component disposed inside the wall of said back iron, and wherein the magnet is supported on the second chassis component.

60. The method of claim 59, wherein the magnet is cylindrical in shape, and wherein the second chassis component contains an annular indentation which is complimentary in shape to a portion of the exterior surface of the magnet and within which the magnet is disposed.

61-62. (canceled)

63. The method of claim 58, wherein molding a chassis includes creating an annular wall around said magnet with the molding material, said annular wall having first and second opposing ends.

64. The method of claim 63, further comprising:
attaching first and second plates, respectively, to the first and second opposing ends of said annular wall;
wherein each of said first and second plates comprises an annular groove which releasably engages one of said opposing ends of said annular wall.

65. (canceled)

66. The method of claim 58, wherein said chassis has first and second ends, and further comprising:
disposing a first synthetic jet actuator on said first end of said chassis; and
disposing a second synthetic jet actuator on said first end of said chassis.

67. A method for making a synthetic jet ejector, comprising:
providing a bobbin having an annular lip with a circumferential groove defined therein;
providing an elastomeric diaphragm having a central opening therein, wherein said central opening is equipped with an annular ridge and has a diameter that is essentially the same as the diameter of the annular lip; and
positioning the diaphragm with respect to the bobbin such that the annular ridge engages the annular groove.

68. The method of claim 67, wherein positioning the diaphragm includes stretching the diaphragm.

69. The method of claim 66, wherein said annular ridge is complimentary in shape to said circumferential groove.

70. A method for making a synthetic jet ejector, comprising:
providing a bobbin having first and second terminals and having a coil of wire disposed thereon which has first and second ends which are attached to said first and second terminals, respectively;
attaching an annular lip with a circumferential groove defined therein;
providing an elastomeric diaphragm having a central opening therein, wherein said central opening is equipped with an annular ridge and has a diameter that is essentially the same as the diameter of the annular lip; and
positioning the diaphragm with respect to the bobbin such that the annular ridge engages the annular groove.
